(19) United States
(12) Patent Application Publication
(10) Pub. No.: US 2013/0185125 A1
(43) Pub. Date: Jul. 18, 2013

(54) SYSTEMS AND METHODS FOR MANAGING OVERAGES IN DAILY DEALS

(71) Applicant: Mastercard International Incorporated, Purchase, NY (US)

(72) Inventors: Jose-Luis CELORIO-MARTINEZ, New York, NY (US); Jonathan Robert Powell, Rye Brook, NY (US); Andrea Christine Gilman, Chappaqua, NY (US); John Doherty, Brooklyn, NY (US)

(73) Assignee: MASTERCARD INTERNATIONAL INCORPORATED, Purchase, NY (US)

(21) Appl. No.: 13/740,630

(22) Filed: Jan. 14, 2013

Related U.S. Application Data
(60) Provisional application No. 61/586,049, filed on Jan. 12, 2012.

(51) Int. Cl. G06Q 30/02

(52) U.S. Cl. CPC G06Q 30/0211
USPC 705/14.13

(57) ABSTRACT

Methods and apparatus are disclosed for using a financial transaction card number system of a payment processing network as part of an overage management system. In an embodiment, a method receives an intelligent transaction card number used with a redemption code to purchase products or services contained in an offer, wherein the intelligent transaction card number indicates a total amount of a transaction and the total includes a value of the redeemed offer and an overage spent by the consumer in addition to the value of the redeemed offer. The method conducts post-clearing adjustments based on terms of the redeemed offer and generates instructions for corresponding credits or debits of funds. The method then receives instructions to: transfer funds from a first purse for the value of the redeemed offer and authorizes, clearing and settling the transferred funds; and to transfer funds from a second purse for the overage.

### FIELD OF THE DISCLOSURE

The present disclosure is directed to a method and apparatus (collectively a system) of managing overages for redeemed offers using in part a financial transaction card processing system or network as a part thereof.

### DESCRIPTION OF RELATED ART

At the time of the drafting of this disclosure, the increased popularity of smart phones, mobile computing devices, and social networking sites has led to new avenues of commerce such as conveying and accepting offers for special deals and discounts. One such avenue involves “a system and methods for offering goods and services of others at a discount on a network such as the Internet, wherein the sale of the goods and services is contingent upon a certain number of actual sales, i.e., a tipping point, where the merchant ultimately providing the goods or services does not pay the out-of-pocket expenses for advertising and marketing the goods or services, and receives the revenue generated from the sales of the discounted goods or services before actually providing those goods or services. Once the customer accepts an offer, payment information for that offer is exchanged, but no payment is actually made. If and when the required number of offers are accepted, i.e., the tipping point, payment based on the payment information is completed.” U.S. Published Patent Application No. 2010/0287103, incorporated herein by reference in its entirety. This patent publication is owned by GroupOn. Similar services are offered by Google Offers, Amazon, BuyWithMe, and Dealon, to name a few competitors at the time of the drafting of this disclosure.

With these deals-and-offers, ‘overage’ refers to the amount a customer spends above and beyond the value of the original voucher or coupon. Overage is very important to everyone in the deals and offers ecosystem as it provides insight into the total value generated to the merchant from running a deal campaign, i.e., the customer not only showed up and redeemed the original coupon, but also spent additional money due to that original coupon or voucher.

Existing payment systems such as MasterCard are largely designed to authorize, clear and settle the full amount entered into the transaction, making it challenging to track and manage overage. This is due in part to the fact that with pre-paid offers, money has already exchanged hands (i.e., between the consumer and the deal company that offered the deal. This is also because, in order to tie or correlate the overage and the redeemed coupon to the same event, typically a transaction must be initated for the full amount (i.e., for the value of the original voucher plus the additional overage). The combination of these two factors makes it technically hard to address overage using existing, traditional systems and techniques.

Accordingly, what is needed are technically based systems and methods for tracking and managing overages for redeemed deal and offer transactions.

### SUMMARY

Methods and systems are disclosed for tracking overage for purchases made at a merchant in conjunction with redeeming a special offer or “daily deal.” Examples of systems and methods for using a financial transaction card (e.g., credit, debit, pre-paid card, virtual, hybrid or nearly any other types of cards used for transacting business) number system as a part of an offer distribution, verification, redemption, reporting and settlement system are described in U.S. application Ser. No. 13/455,951, entitled “METHODS AND SYSTEMS FOR OFFER AND DYNAMIC GIFT VERIFICATION AND REDEMPTION,” filed on Apr. 25, 2012; and U.S. Provisional Application No. 61/586,049, entitled “SYSTEMS AND METHODS FOR MANAGING OVERAGES IN DAILY DEALS,” filed on Jan. 12, 2012, which are incorporated herein by reference in their entirety.

The overage management methods and systems described herein use an integral approach both from the issuer and acquirer sides.

In one embodiment, post-settlement debit or credit adjustments are conducted. According to this embodiment, purse functionality is used to separate the value of a voucher associated with an offer from overage, but both the voucher value and the overage amount settle normally. In this embodiment, post settlement adjustments are used to pull or debit from a merchant amount settled corresponding to full value of the voucher. A total amount (voucher value and the overage) can be entered at a merchant's point-of-sale (POS) so that a consumer would see a ticket or receipt for the total amount of goods and services purchased at the merchant, which may be helpful when calculating suggested gratuities and taxes. According to this post-settlement embodiment, a single transaction at a POS can help manage overage and validate a voucher.

In another embodiment, a non-settlement product is used. In accordance with this embodiment a new authorization/clear only product is used to avoid settlement challenges. For example, the non-settlement product can use partial authorization to authorize the amount of the voucher only, exclusive of any overage, which will be paid for via a subsequent transaction. An advantage of this approach is that it can eliminate the need for validation workarounds. Another advantage is that merchant settlement can be handled through other systems (e.g., Purchase Control™, Bill Pay™).

In yet another embodiment, a separate system is employed to track overages associated with redeemed deals. According to this embodiment, a virtual card number (VCN) is used to track deal redemption. In accordance with this embodiment, a reward services platform, such as, but not limited to the MasterCard Rewards Services (MRS) can be used to track overage. Such an overage tracking system can combine features of MRS with MasterCard's InControl™ authorization system to “track” overage—a key metric for deal companies and deal distributors. This embodiment incorporates MRS card registration, thus expanding options for future deal offerings.

According to another embodiment, reverse settlement with an additional funding mechanism is used to manage overages. In this embodiment, an Intelligent Coupon Number (ICN) is used for the full amount (total of the value of a voucher for a deal and the overage) and off-network reconciliation is conducted post-transaction. In other words, an initial charge to the consumer for the voucher amount and overage occurs, with a subsequent discount being applied later. In this embodiment, reverse settlement handles the extra funds paid to a merchant as a result of entering the full amount initially and overage is charged to a consumer's funding mechanism (e.g., a pre-paid card, credit card, or debit card). Unlike a spending purse which can trigger authorizations at the same time, in this embodiment, all the reconciliation occurs ‘off the network.’

Single use coupon numbers that allow consumers to print vouchers as they do today, but bearing the single use number and are validated using existing payment network capabilities.

Physical, plastic redemption cards that can be issued to consumers who can redeem their vouchers by swiping their redemption cards without needing to print out a paper coupon.

This system provides an electronic solution for points of sale coupon processing that provides real time authentication of the coupon to mitigate potential coupon miss-use at retail locations worldwide, and one that creates a seamless process for the consumer.

Embodiments also fulfill overage tracking and reporting needs, and enable systems to make offers and deals “go live” (become available to the public) to consumers in real time. Additionally, the systems described herein provide solutions that allow offer distributors to settle with their merchant partners utilizing a commercial purchase control platform, which funding administrators utilize. In this way, embodiments are adaptable to legacy financial transaction account systems and point-of-sale (POS) systems currently in use.

Also, in part because the present system can be carried nearly entirely as part of a pre-existing payment processing network, in cooperation with the offer distributor and others, overage tracking and reporting can be across many different merchants and other offer sponsors, offer distributors and consumers, rather than needing to be implemented through each POS terminal, creating alternative communication paths, requiring users to access various websites for different and perhaps confusingly different processes and functionality, etc. As such, the process, reporting, analytics, and acceptance can become an industry standard and lower the threshold to adoption of the technology by consumers and offer distributors and sponsors alike.

These and other features and advantages of the present invention will become apparent from the following detailed description of illustrative embodiments thereof, which is to be read in connection with the accompanying drawings.

### BRIEF DESCRIPTION OF THE DRAWING FIGURES

FIG. 1 is high-level computer architecture of an exemplary financial processing system for carrying out the presently disclosed system.

FIG. 2 is a data flow diagram overlaid on a computer architecture diagram.

FIG. 3 is a block diagram illustrating bi-directional communication of the financial processing system of FIGS. 1 and 2 for tracking overages, according to an embodiment of the disclosed system.

FIG. 4 depicts a method for overage management using post-settlement adjustment, according to an exemplary embodiment of the present disclosure.

FIG. 5 depicts a method for overage management using a non-settlement product, according to an exemplary embodiment of the present disclosure.

FIG. 6 depicts a method for overage management using overage tracking, according to an exemplary embodiment of the present disclosure.

FIG. 7 is a data flow diagram for the post-settlement adjustment method depicted in FIG. 4, according to an exemplary embodiment of the present disclosure.

FIG. 8 is a data flow diagram for the non-settlement product depicted in FIG. 5, according to an exemplary embodiment of the present disclosure.

FIG. 9 is a data flow diagram for the overage tracking depicted in FIG. 6, according to an exemplary embodiment of the present disclosure.

FIG. 10 is a data flow diagram of deals processing platform used to implement the non-settlement product depicted in FIG. 5, according to an exemplary embodiment of the present disclosure.

FIG. 11 is a diagram of an exemplary computer system in which embodiments of the present disclosure can be implemented.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION

As used herein, “credit card number” is sometimes used interchangeably with financial transaction card number and payment card number. These mean a credit card, debit card, pre-paid card, hybrid card, plastic or virtual card number (VCN), or nearly any other account number that facilitates a financial transaction using a transaction clearance system and are either directly associated with a line of credit, or associated or linked with another account that is directly associated with a line of credit. VCNs and pre-paid card numbers and other financial transaction card number that can be generally viewed as being more readily issued and disposed of because they do not require the establishment of a line of credit, and can be linked to various controls (amounts, cumulative amounts, duration, controls on spending by amounts, cumulative amounts, types of merchants, geographic controls, to name a few). As used herein, these types of cards (VCN, pre-paid, etc.) are referred to as intelligent transaction card (ITC) numbers. An “overage” is an amount spent by a consumer at a merchant above and beyond the amount of an offer or voucher being redeemed by the consumer at the merchant.

I. System Architecture

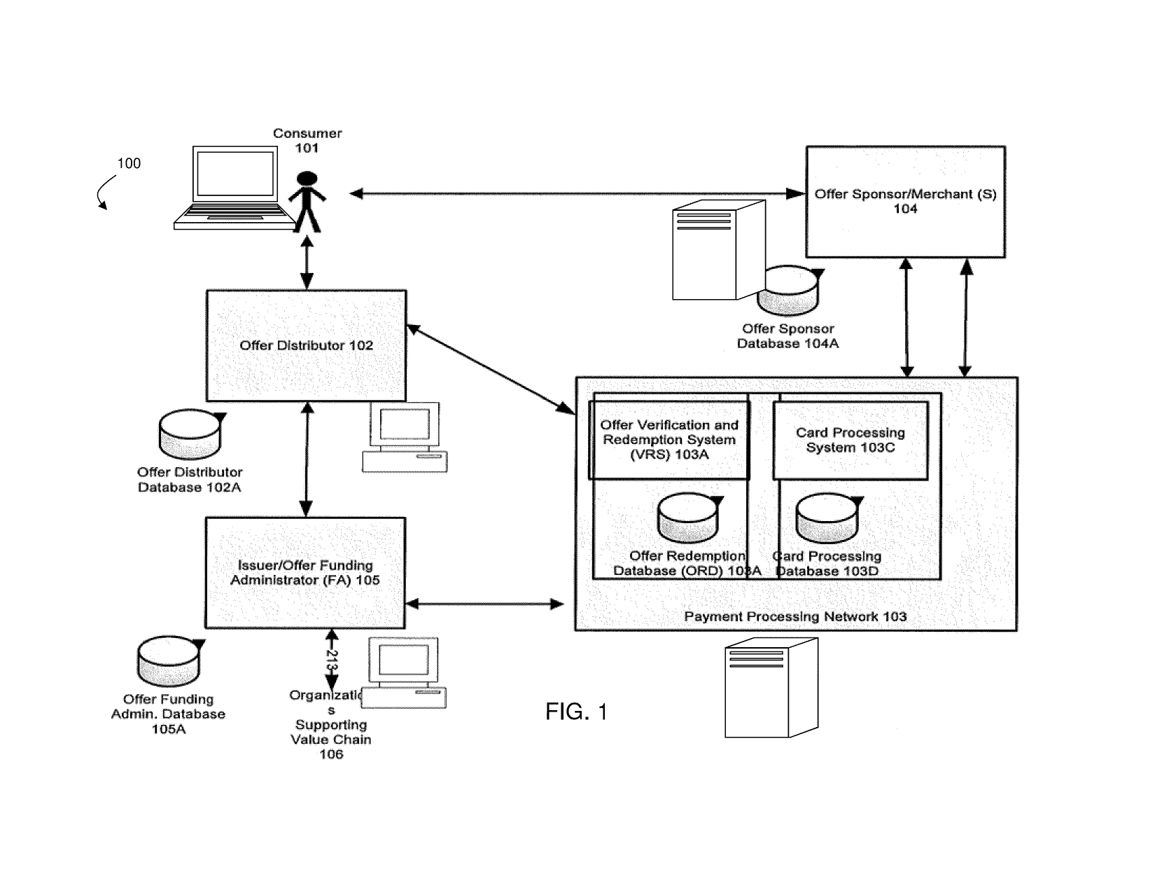

With reference to FIG. 1, credit card companies such as payment processing network 103 provide various services and product offerings to support its customers and vendors. One such product offering, InControl™, allows cardholders to set custom controls on usage of their credit, debit and prepaid cards, and even block transactions that they deem inappropriate. Additionally, it enables cardholders to receive real-time alerts about card activity via email or text message. As a result, they can manage their finances more efficiently and spend with greater confidence. This is accomplished by using virtual card numbers (VCNs) that are formatted and are processed the same as regular credit and debit card numbers by merchants and acquirers, but at the issuer or at the card processor (e.g., MasterCard), the VCN is mapped in a database to the regular card number for normal authorization checks, and also to controls that are in addition to the normal authorization checks that can be set by the card holder, such as spend limits (both maximum amount per transaction and over a time period), limits on types of merchants or a single merchant, geographic location based controls, etc. See, U.S. Pat. No. 6,315,193; U.S. Pat. No. 6,793,131; U.S. application Ser. No. 10/914,766, filed on Aug. 9, 2004; U.S. application Ser. No. 11/560,212, filed on Nov. 15, 2006; U.S. application Ser. No. 12/219,952, filed on Jul. 30, 2008; and International Application No. PCT/US2009/005029, filed on Sep. 19, 2009, U.S. Published Patent Applicaton No. 2009/0037333, filed on Jul. 30, 2008, all incorporated herein by reference in their entirety (herein the controlled payment numbers or CPN Patents). One iteration of a VCN is a P-card™ or Purchase card, which can have limits set by a supervising entity and used by another (e.g., a boss sets limits on the P-card given to an employee).

As implemented in the presently described exemplary embodiment, the computer architecture 100 depicted in FIG. 1 includes a consumer 101, an offer distributor 102, payment processing system 103 (e.g., MasterCard's InControl™ authorization system, pre-paid card authorization system or other intelligent transaction card number processing system or network), an offer sponsor/merchant 104 and a funding administrator 105 (e.g., a bank or other financial institution). Payment processing network 103 and other financial transaction card processors, networks and issues also offer prepaid card processing. Communication between the various components can be through public and/or private networks or virtual private networks (e.g., the Internet particularly with respect to communications with the consumer, and private networks for others).

The consumer 101 can be a natural person, but generally as used herein to refer to a computing device associated with a consumer, such as, but not limited to, a computer connected via a browser to the Internet. Architecture 100 allows a consumer 101 to use any mobile computing device to accept offers from offer distributor 102, including, but not limited to, a Personal Digital Assistant (PDA), a tablet computing device, an iPhone™, an iPod™, an iPad™, a device operating the Android operating system (OS) from Google Inc., a device running the Microsoft Windows® Mobile OS, a device running the Microsoft Windows® Phone OS, a device running the Symbian OS, a device running the webOS from Hewlett Packard, Inc., a mobile phone, a BlackBerry® device, a smartphone, a hand held computer, a netbook computer, a palmtop computer, a laptop computer, an ultra-mobile PC, a portable gaming system, or another similar type of mobile computing device having a capability to accept offers from offer distributor 102.

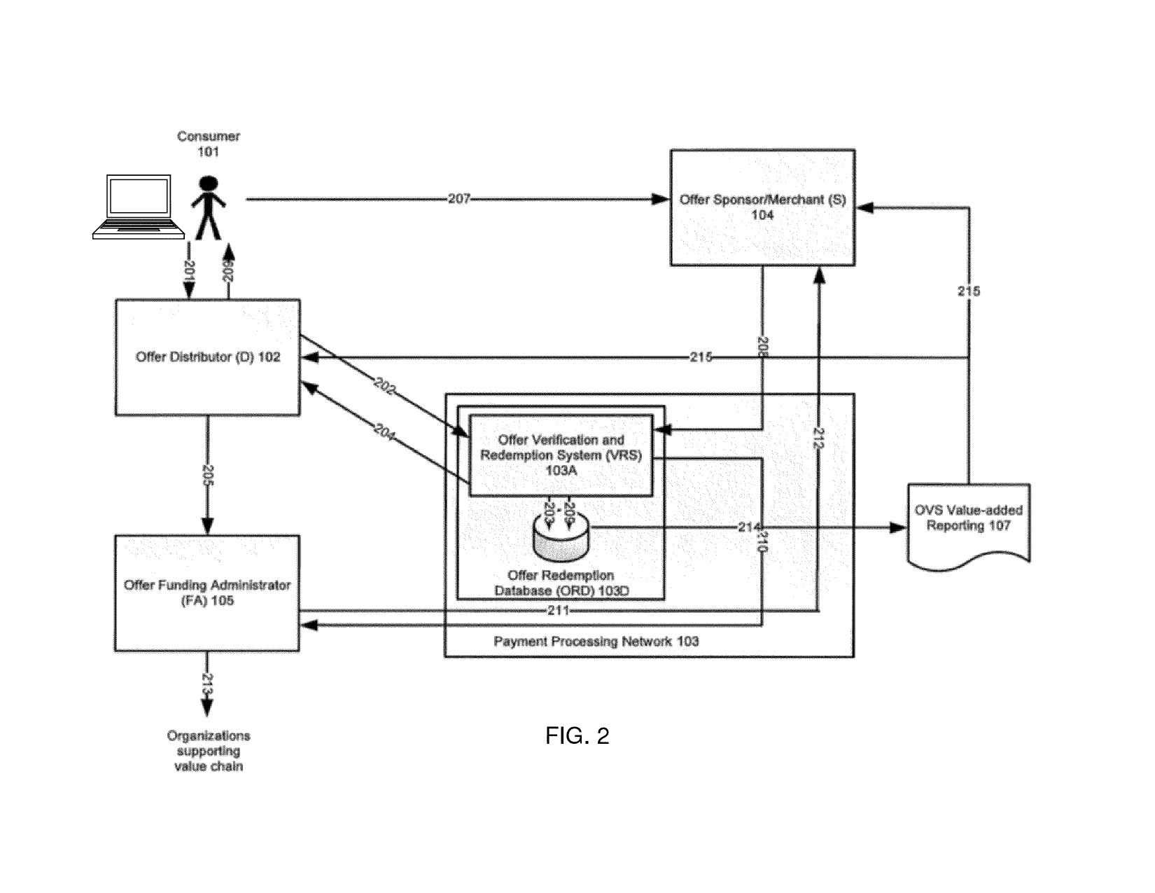

As illustrated in FIGS. 1 and 2, a computing device associated with consumer 101 includes a user interface (such as the screen shown in FIGS. 1 and 2) and Input/Output (I/O) devices (such as the keyboard depicted in FIGS. 1 and 2 and mouse (not shown) and/or touch screen) which can be used to view received offers and to transact business, including making payment as part of accepting an offer using a financial transaction card (credit, debit, pre-paid, virtual, hybrid or nearly any other types of cards used for transacting business). This is shown in FIG. 1 by the two-way arrows inter-connecting the customer 101 to offer distributor 102 (e.g., a deal website) and to a merchant 104.

The offer distributor 102 may be a single entity or multiple parties (e.g., deal originators such as GroupOn and the like), deal aggregators, and deal publishers, whether working independently or collectively, but each entity that has computers, databases 102A and servers and/or routers to distribute offers for goods or services, often at a discounted price or other special deal. The distributor 102 can be a website or service (e.g., GroupOn), advertising agency, or part of a merchant, payment processing network or card issuer to name a few possibilities. The offer distributor 102 may only distribute offers on behalf of another, but may compose, target, track and report usage of various offers to the merchant providing the product or service or others. It has a user interface and at least the conventional I/O devices. Though only one is shown, each offer distributor may have many I/O devices and computers computer systems, servers, routers and network(s), and there may be many of the offer distributors 102 working together or independently on this embodiment.

Depending on the offer or deal, distributor 102 may have the ability to mass distribute offers. It may also have databases (e.g., offer distributor database 102A) and processors to distribute the offers over the Internet or on paper or other media, preferably through targeted marketing to a plurality of consumers 101 who have been determined to qualify for the offers. In one embodiment, relevant deals are presented to consumers via a deal website based on previously-received consumer preferences, deal ratings, merchant rating thresholds, and transaction history for consumer cards which have been previously-registered with offer distributor 102.

The payment processing network 103 processes transactions that use financial transaction cards by receiving authorization request from merchants through acquirers, in conventional manners and in manners described in the above-mentioned CPN Patents. Exemplary payment processing networks 103 include MASTERCARD, VISA, AMERICAN EXPRESS, DISCOVER, DINERS CLUB, etc., to name a few. The payment processing network 103 can communicate by two way communication to the offer distributor 102, the issuer, which might be the same or a different entity from the offer funding administrator 105, and the offer sponsor/merchant 104, both directly and/or through an acquirer (not separately shown). It includes a conventional card processing system and database 103D for routing to the appropriate issuer and sometimes processing of transactions (stand-in processing) for authorization. The payment processing network 103 also route authorization messages to the appropriate merchant, and other functions of a conventional payment processing system. Additionally, it might be set up to send transaction details and details about which entity (101, 102, 103, 104 and 105) is to get what type of consideration (financial compensation, like-kind compensation, discounts, rewards, etc.) stemming from a transaction. That is, each party (including the customer) to the transaction might receive a portion of the purchase of the product or service through the redemption of the coupon, and the payment processing network 103 could determine and facilitate this part of the transaction, or pass the necessary information on to the offer funding administrator 105.

The payment processing network 103 also has conventional UI and I/O devices, and though one is shown, it should be noted more than one payment processing network 103 can be used. The illustration is simplified for clarity, but can and usually does involve stand-in processing, routing, multiple exchanges, etc. in a commercial system.

A merchant 104 offers goods and/or services and sponsors various offers for the merchant's products or services. It can communicate with the consumer 101 and the payment processing network 103, usually through an acquirer, via two way communications. The merchant 104 can be a brick-and-mortar business in which consumers visit the facility, and more optimally, a merchant that have a presence on the Internet and capable of e-commerce, complete with web servers and transaction processing computers and a database 104A, communicating via http, https and other network communication protocols, for instance. It too has at least the conventional UI and I/O devices discussed above with reference to computing devices used by consumer 101.

The merchant setup process captures the deal information including locations, timeframe, discount and validation of the token value used to validate the GroupOn offer/deal.

The Offer Verification and Redemption System (VRS) 103A shown in FIGS. 1 and 2 may have the flexibility to limit a deal to a single merchant with one or multiple locations. By assigning the coupon a VCN number, the card processing network 103 (which might include InControl™) can validate the offer using the Acquirer ID (DE 32) and Card Acceptor ID(s) (DE 42). The Card Acceptor ID is specific to the merchant location on the payment processor authorization network. This will support a single merchant location model or a subset of locations for a multiple merchant location model.

Reporting can be based on the authorization logs captured by either payment processing network 103 or funding administrator 105, and can provide information on offers sold and redeemed across all merchants—a critical data element not available as of the drafting of this disclosure. These can detail the authorization decision, the merchant and the date and time. Additional detailed reporting can be created using the InControl™ APIs (Application Program Interfaces) that would be specific to business requirements.

Key metrics that would be part of the service and made available to merchants and deal companies, as well as industry watchers and other interested and authorized parties as appropriate, include redemption rates, gross and net value, gross and net revenue, return on investment and overage rates (a key metric particularly when the deal is being offered as a loss leader) and other measures of effectiveness. To the degree authorized, the redemptions and other metrics can be analyzed to drive marketing efforts including direct marketing insofar at the ITC numbers can act as anonymous or anonymized identifiers for grouping consumers to act as statistical panels and/or multivariable population segments for targeting marketing. For example, consumers can be grouped into segments of people who obtain but do not redeem coupons, consumers who obtain and redeem coupons but have low overage rates, and consumers who obtain and redeem coupons and have higher overage rates, to name but one way to segregate consumers in a way enabled by this technology.

II. Method

Exemplary methods of overage tracking shall now be described with reference to the several drawing figures.

A coupon for each customer receiving the coupon would have a unique VCN created that is associated with a real card number on an issuer's platform. The real card number (RCN) would be an active account with the issuer with enough “open-to-buy” (or available credit) to support the total purchase amounts associated with all the vouchers associated with it. When the VCN is received in VRS platform 103A for authorization approval, these controls would be checked. If all the controls are validated the transaction would be forwarded to the issuer for their decision with the RCN as the PAN. If the controls are not validated the merchant would receive a decline response code from their acquirer and would not accept the GroupOn as payment for services. If the issuer approves the transaction (after fraud, open to buy, expel date checks), the approval response is forward back to the merchant's POS via the acquirer. As part of this check, the following rules and processes may be applied:
Merchant ID/Location Rule; review each of:
   Merchant name
   Acquirer ID
   Card Acceptor ID
Offer Validity Immediacy—VRS platform 103A can support the offer going “live” the moment the group threshold is reached, and consumers will not have to wait to begin using their voucher, thereby improving the consumer experience
Offer Validity Period Rule—The VRS platform 103A can support different validity period rules within one coupon offer—if it is a desire to spread the effective date of the offer over a period of time that is advantageous to the merchant or other party (a form of load balancing), the start and stop dates can be for example; the month of August for the first third of the individual vouchers, September for the next third and October for the final third. Additionally if it is a non-weekend or Monday night special offer that type of validation can be provided for as well. These checks may be made:
   Transaction Date>=Start date
   Transaction Date<=End date
   Transaction Date=End date
Transaction Count Rule—this rule can be changed by the offer distributor 102 if there is a ‘user’ error. So if the user error dictates that they need a second swipe, the offer distributor 102 customer support person can up the counter in real time to ‘2’ and the merchant can run the validation again.
Transaction Amount Rule; review each of:
   Amount=nominal amount for that merchant
   Amount=the merchant's portion of the coupon purchase price
Spending Limits—this control can be used to limit the coupon to a validation only service in this case it would be set to the amount that ensures the transaction is routed to the VRS platform 103A. It can also be used to pay the merchant for their portion of the purchased coupon. In either case this can be an upper limit or an exact amount. In the cases of restaurants or other merchants where a tip is customary the tip amount is handled in the authorization by the merchant's processor.

Settlement of the coupon or voucher regardless of the amount may be a normal card settlement process between the card processor, funding administrator 105, the merchant acquirer and the merchant who processes the transaction. Settlement of funds would include interchange as dictated by the underlining product/transaction matrix. On a daily basis funds for purchases would be transferred from the funding administrator 105 settlement account net interchange into the merchant acquirer's settlement account net interchange.

The individual voucher for each customer would be inserted into the VRS database 103c at the time the voucher threshold of customers is reached to activate the voucher by an offer distributor 102. For example, where an offer becomes valid after a certain level of acceptance, once that level of acceptance (e.g., a specific number of vouchers are purchased or designated for purchase), then the offers become redeemable. Similarly, if an offer was continent on some criteria (e.g., the consumer needs to spend a specific amount (e.g., $100) before the offer can be redeemed (e.g., 10% off of total amount or amount above the triggering amount, etc.), then during the payment transaction (e.g. the authorization process initiated by the attempted redemption) the offer can become redeemable by action of the VRS 103A upon that condition being satisfied.

Each customer would have a VCN uniquely assigned by payment processing network 103 for each voucher they qualify for and is requested. So if the offer threshold was 50, 50 VCNs would be requested by the deal distributor system with the same controls and loaded into the systems via (APIs). The deal distributor 102 would receive back the VCN with the confirmation of success for each request and they would associate that with the customer for live cycle customer servicing.

Connectivity into the VRS platform 103 may be Secure Sockets Layer (SSL) 128 bit encryption supporting the Extensible Markup Language (XML) APIs with server based certificates issued for this service, for example. Collectively firewall rules would be executed to allow this TCP/IP traffic to flow between the payment processing system 103 and the deal distributor servers via the Internet by way of a non-limiting example. Additionally, if the funding administrator 105 wants a view into the VRS databases via the same APIs they would need to implement similar connectivity rules.

### Offer Acceptance

The offer acceptance process is described below with reference to FIG. 2. In step 201, a consumer 101 accepts an offer from an offer distributor (D) 102. For example, a consumer 101 might receive a text message, e-mail, multi-media e-mail that informs him from its content or links to other content of a discounted offer (e.g., “50% off regular price at Suzy's Nail Salon for a manicure”).

In step 202, the offer distributor 102 requests an offer redemption code from an offer verification and redemption system (VRS) 103A. The offer redemption code may take the form and format of a financial transaction card (e.g., regular credit/debit/pre-paid card number or a virtual card number (VCN)). In other embodiments, the offer redemption code and the financial transaction card are distinct from each other. In the former, the offer redemption code can be used as the redemption code and as a VCN as a stand-in for a regular credit/debit/pre-paid card number. In the later, the offer redemption code can be tied to a general offer (e.g., a widely distributed coupon or promotion code), whereas the VCN can be specific to a given transaction.

The offer distributor 102 receives payment from the customer 101, and that payment is used, at least in part, to apply funds to the VCN that is returned to the customer for presentation to the merchant 104. Of particular usefulness is a P-card embodiment of a VCN because the offer distribution 102 or the merchant 104 can act as a supervisory authority setting limitations on the VCN use in accordance with the offer parameters and the customer can use the CPN within these parameters.

In addition to what is described above, the information returned in the APIs for the VCN creation would provide the deal distributor 102 the VCN they need to print on the voucher PDF or include in the mobile app content, which also might provide the VCN creation API as well. One solution is a real time solution, meaning as soon as the VCN request is processed and confirmed on the VRS platform 103a, the deal distributor 102 can notify the customer of the offer and it can be used at the merchant. Additionally when the voucher is used at the POS, an alert can be passed via SMS service or another messaging means to the deal distributor 102 to let them know the customer is apparently satisfied and in the act of using their product. This would be useful for follow up offers via a mobile device, surveys or sharing information on the status of others offers, for example.

Based on the volumes and other business requirements a number of new bank identification numbers (BINs) would be provided and implemented on the payment processor's systems to be allocated for the VCN for the vouchers. One BIN can handle over 900 million active VCN concurrently. The actual number available is based on any qualifying business rules that would impose restrictions on digits 7-15 of the VCN. The actual number assigned to a customer's voucher is generated base on a preprogrammed scheme that all parties would agree to and validate as part of a particular implementation under one approach.

If the deal distributor 102 decides for whatever reason an active voucher needs to be cancelled, the APIs can be used to support that requirement.

For most cases the deal distributor 102 will have either a copy of the PDF or the raw data in their database to recreate the PDF for life cycle customer servicing. If the deal distributor 102 needs the details of a VCN there is an API to provide the details of an individual VCN on the system.

Though called a funding administrator 105, a funding account is not required when the underlining account is a credit account. What is required is open-to-buy, i.e., sufficient available credit, on that account so the transactions regardless of the amount are approved by the issuer.

In an instance when the VCN is declined or consumer would like a refund (low satisfaction), the VRS platform 103A may allow the deal distributor 102 to modify/cancel the VCN in real time. All information about each voucher can be accessed by APIs or via the associated web based customer service platform. Consumer could inform the deal distributor's customer service representative about the issue. A customer service representative will be able to change the Transaction Count Rule (mentioned above) for the utilization of the VCN from “# of uses=1” to “# of uses=2” for example, while the customer is on the line.

When a financial transaction card is received for payment by a merchant, the merchant generally cannot tell whether it is a VCN or a credit card number that represents the permanent account of the card holder. The VCN is submitted (as explained below) to an acquirer that in turn submits the VCN as part of a request for authorization for the transaction through a card payment processing network 103 to the card issuer 105. At the card issuer 105 or at the card payment processing network 103, if the financial transaction card is a VCN, it is identified (usually by the routing or BIN number forming the first few digits of the number) and the VCN is mapped back to the regular account of the consumer 101, after (but alternatively this can be done later in the process) checking the VCN against additional approval criteria (beyond the normal balance available/active card checks) which might include criteria set by the customer 101 is a normal operation. As will be seen below, here the system adds controls/usage limits specific to the particular offer so that it is good only for the particular offer and cannot be used for other types of transactions, for example. Pre-paid cards are similar to VCNs in that they can have unique numbers that can also be linked to controls on usage, and as a tracking number for specific transactions, for example, and can be modified to be associated with a particular offer, as explained below. Any form of intelligent transaction card (ITC) number that can be linked to information ancillary to the financial transaction card processing (such as funding account information), can be used, however.

Intelligent transaction card numbers can be requested one at a time or in batches. That is, an offer sponsor/merchant (S) 104 could buy multiple ITC numbers/redemption codes and distribute at will, or upon each desired transaction. Though generally the ITC numbers will remain virtual, it is also contemplated that they can be printed or embossed on cards or other forms of physical media for distribution to customers or potential customers 101.

Intelligent transaction card numbers/redemption codes are linked to offer funding accounts in a database 103D that is managed at a payment processing network 103. More specifically, the ITC numbers will be linked to offer funding account managed by the funding administrator 105. Customer's credit card is used to load funds into the offer funding account managed by the funding administrator 105. So, the funding administrator 105 manages one (or more) offer funding accounts that contain the aggregate funding required to settle offer-related purchases. The offer funding account administrator 105 may but does not have to be the issuer of the regular credit cards or the ITC numbers. For instance, the offer funding account administrator 105 may manage funding account(s) to manage aggregate offer funding and may be configured at offer distributor 102. That is the offer distributor 102 can be a service of the issuer of the credit card or the ITC numbers, or be a separate entity.

Usage limits for offer redemption code are included with this request. These limits are consistent with terms of offer (e.g., merchant, amount, time period of offer, etc.) that are determined by the merchant and implemented in the VRS platform 103A in this particular embodiment, but the usage limits can be set by the offer distributor 102, or perhaps even by the consumer 101 within parameters (a set-your-own price type offering) or other criteria. In the present non-limiting exemplary embodiment, the usage limits are stored in an offer redemption database 103B of the VRS platform 103A, which may be part of the normal payment processing network 103, or may be a separate entity, or a service provided at an issuer. The offer redemption database 103B permits the usage limitations be checked for validity before, concurrent with or after the VCN is used to map the transaction details to an offer funding administrator (FA) 105 for normal authorization processing. Additionally, offer descriptive data may be provided by the offer distributor 102. Examples of this data include offer code/name and consumer ID, to name a few. This data can be used to support value-added reporting services, such as facilitating targeted marketing, return on investment reporting, etc.

In step 203, offer acceptance is recorded in the offer redemption database (ORD) 103B. In a simple embodiment, ITC number's issuance indicates offer acceptance, but activation scenarios are contemplated, e.g., akin to gift card activation is instances where the intelligent transaction card numbers/redemption code is distributed to potential consumers as part of the offer. ITC number spending controls, also referred to herein as usage limits, are established to bind ITC numbers to date/amount/merchant sponsor of offer. Other spending controls (e.g., merchant type, location, purchase frequency, redemption periods) may be employed for other offer types, and still other combinations of usage limits can be employed depending on offer parameters. Additionally the consumer 101, offer funding administrator 105 or offer sponsor/merchant 104 might be given the opportunity to add his or her or its own controls that are not strictly required by the offer or its acceptance (which might be one of the above or something completely different).

In step 204, the offer redemption code ITC numbers are returned to the offer distributor 102.

In step 205, the balance of offer funding account is incremented by cost of offer. This cost may be paid by consumer (using funding method of choice including payment accounts or points account) or another entity that has agreed to subsidize all/part of the offer cost.

In step 206, the offer redemption code/ITC numbers are provided to consumers. Provision of offer code may be via printed certificate, electronic certificate (e.g., mobile app, email, text) magnetic stripe payment card, NFC (Near Field Communication) enabled payment device (e.g., mobile phone), chip/smart card, QR or other 2D bar code or other optical, wireless (NFC) communications, or device/media format that can be used to conduct payment processor-based (e.g., MasterCard-based) payments. Two amounts are provided as part of redemption code: offer value ($OV) and offer redemption amount ($ORA). $OV is the offer worth to the consumer. $ORA is the amount merchant is reimbursed for the goods or services upon redemption payment request.

According to one embodiment, an alternate solution to having different $ORA and $OV is to leverage IPS (Integrated Processing Systems), pre-paid card processing or other intelligent transaction card processing for remittance processing to facilitate the appropriate settlement across the offer distributor 102, the offer sponsor/merchant 104, the offer fund administrator 105 and the payment processor (e.g., MasterCard) 103.

For example, third party POS software vendors and application provides can provide much of the functionality of the present methods at the POS, such as automatically calculating the overage, automatically splitting the transaction to obtain a partial authorization for the redemption value and run a separate transaction for the overage, perhaps in a manner that presents to the consumer a receipt that reflects the redeemed value, the applied discount and the overage as separate items. The receipt could also provide additional advertisements perhaps driven by the analytics and/or reporting 107 of FIG. 2, for instance.

IPS could apply fees against cards and programs to facilitate needed charges and remittance to the involved parties, depending on implementation. IPS could receive payments requests, authorize the payment transaction, and apply appropriate fees. Alternatively or additionally, the necessary information could be passed onto another of the involved parties, such as the offer fund administrator 105. Yet another alternative is to have the intelligent transaction code be associated with controls for split payments. For example, payment to the merchant can be divided up over time, one being at the offer acceptance (e.g., within 5 days of the sale), one sometime later (e.g., 30 days) and one even later (e.g., 45 days), for cash flow purposes. In fact, the intelligent transaction code could be set up at the time of acceptance that if various triggers (e.g., redemption or expiration) various parties could receive a portion of the offer as scheduled by the ORD 103A, for one example.

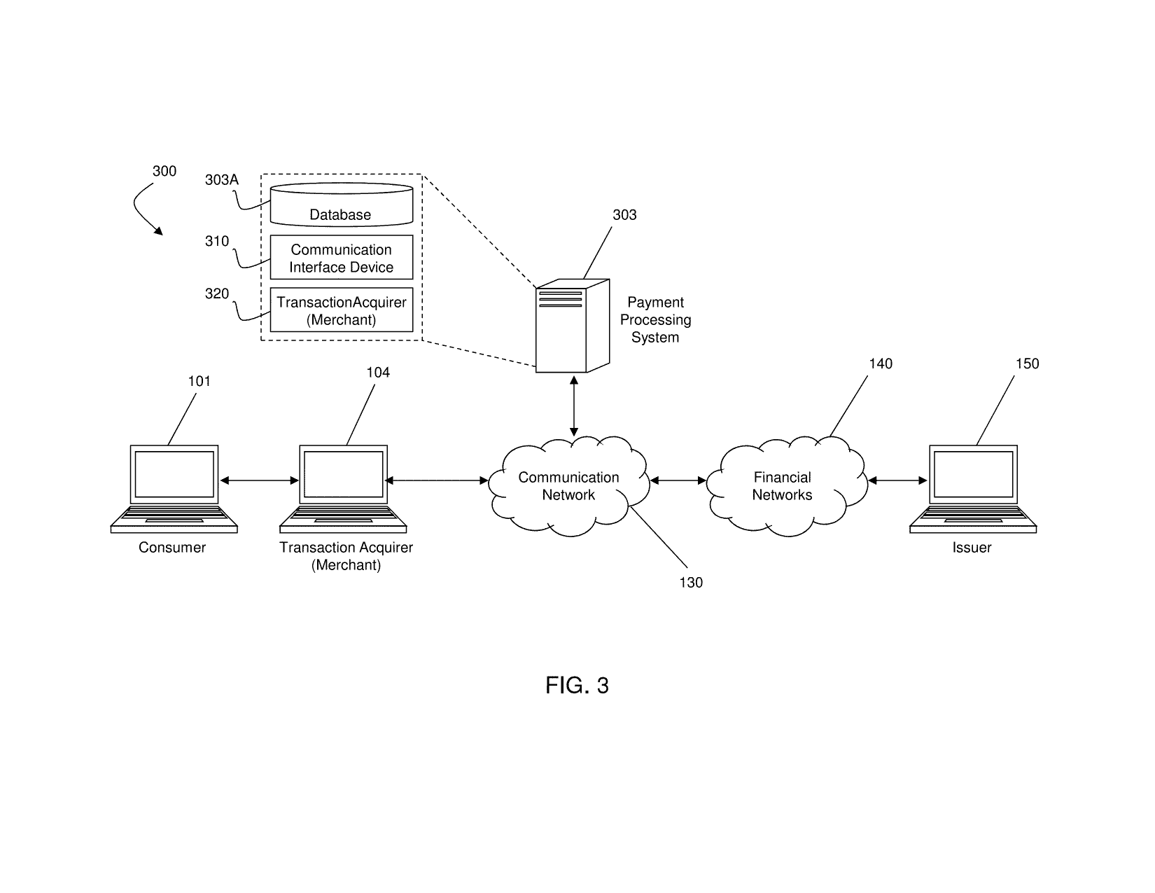

FIG. 3 illustrates an overview of the overage processing architecture 100 of FIG. 1 within an overage management system 300 including bi-directional communications between the components of overage processing architecture 100 FIG. 1 with parties external to overage processing architecture 100 for managing overages. As illustrated in FIG. 3, the overage management system 300 includes at least a consumer 101, a transaction acquirer (merchant) 104, an issuer 150, and a payment processing system 303. The consumer 101 engages in a financial transaction with the transaction acquirer (merchant) 104. Such financial transactions can be, for example, point-of-sale (POS) transactions, or transactions that are performed electronically, such as through the Internet. Types of consumer-merchant transactions that can be used in the overage management system 300, as well as the information exchanged between the consumer 101 and merchant 104, will be apparent to persons skilled in the relevant art(s).

As illustrated in FIG. 3, the payment processing system 303 communicates with the merchant 104 and the issuer 150 via communication network 130. Specifically, the payment processing system 303 receives specific transaction information pertaining to a financial transaction between the merchant 104 and consumer 101, which is transmitted through the communication network 130 upon initiation of the financial transaction. The payment processing system 303 processes the transaction by forwarding the transaction information through a particular financial network 140 and transmitting an authorization request to the issuer 150. The issuer 150 can be, for example, a bank that had issued the credit card that the consumer 101 used in the financial transaction. The issuer 150 will then return either an authorization or denial of the financial transaction to the payment processing system 303 via the communication network 130. Once the payment processing system 303 receives authorization of the financial transaction from issuer 150, and if the transaction information meets predetermined criteria, the payment processing system 303 is configured to transmit overage information via communication network 130 to merchant 104. The overage information, in some embodiments, can be received via communication interface device 310 by transaction acquirer merchant 320 and stored within the database 303A of the payment processing system 303. Thus, further communication between the offer distributor 102 shown in FIGS. 1 and 2 and payment processing system 303 could be limited. In other embodiments, the offers may not be released from offer distributor 102 until a financial transaction occurs thereby triggering communication between the payment processing system 303 and offer distributor 102.

As discussed in U.S. application Ser. No. 13/455,951, entitled “OFFER VERIFICATION AND REDEMPTION METHOD AND SYSTEM,” the process of purchasing a coupon or voucher includes the customer buying an offer by entering such information as card information including name, billing address, card number, secure code, and expiration date and agrees to terms and conditions. An offer distributor 102 such as GroupOn can sell a coupon for ten dollars and will receive twenty dollars of service at a merchant 104, such as Maria's Spa. Next, a card is validated and the purchase is completed using the normal payment mechanisms. An offer distributor 102 such as GroupOn requests a VCN from the offer verification and redemption system 103A such as MasterCard's InControl™. The offer verification and redemption system 103A then sends the VCN to the dealer/distributor 102, which in turn causes the coupon to be received by the customer as a voucher or the like that bears the VCN. It should be noted that the voucher may be paper, or an electronic or nearly any other form of delivery.

As further described in U.S. application Ser. No. 13/455,951, VCN mapping involves an offer distributor 102 such as GroupOn requesting a VCN by sending the offer verification and redemption system 103 such data as the identity of the funding RCN, the VCN (back identification number), the merchant identification or ID such as the require ID or the card acceptor ID. The offer distributor 102 also sends a validity period, a transaction environment (all, ecommerce only, paypass/mobile tag or POS, or combinations thereof) the transaction number (x=1 or more if more than one transaction is contemplated). Additionally, the spending limit can be identified. Some of these data sets can be required, while others remain optional. At the offer verification and redemption system 103 in conjunction with the offer redemption database 103A, data is recorded in the platform and the payment processing network 103 generates a VCN for transmission back to the offer distributor 102 containing all of the appropriate controls.

### Offer Verification and Redemption

Having covered offer acceptance, now offer redemption will be described with continued reference to FIG. 2. In step 207, redemption of an offer or deal commences when consumer 101 presents offer redemption code (which may be an intelligent transaction card number) to an offer/sponsor merchant 104 for payment of goods/services.

Consumer 101 presents the voucher with a VCN, expiration date, possible CVC value and possible amount on it to the merchant in order to redeem the offer.

The merchant 104 runs a normal POS transaction using the deal administrator of information on the voucher as input to their POS device. This can include the VCN, EXP date, CVC and amount to validate the offer.

Upon receiving the transaction, the VRS platform 103a will check the transaction data against the VRS database 103c and apply the rules encoded with that VCN and validate the transaction. The ability to latch the exact merchant and location to the VCN is controlled by the encoding in the terminal and information provided in the transaction by the merchants POS system and the acquirer prior to the transaction reaching the payment processing network 103. The VRS platform 103A confirms the merchant is correct by comparing that information to the information provided in the original VCN request when it is created. It is based on synchronizing the merchants/acquirer information between the VCN creation and the POS transaction that ensures the voucher is used at the correct merchant location and mitigates reuse or misuse for the deal distributor 102.

At this point, the merchant 104 receives either an approval or a decline as to the validity of the voucher. These codes would be the same they receive today for their transactions.

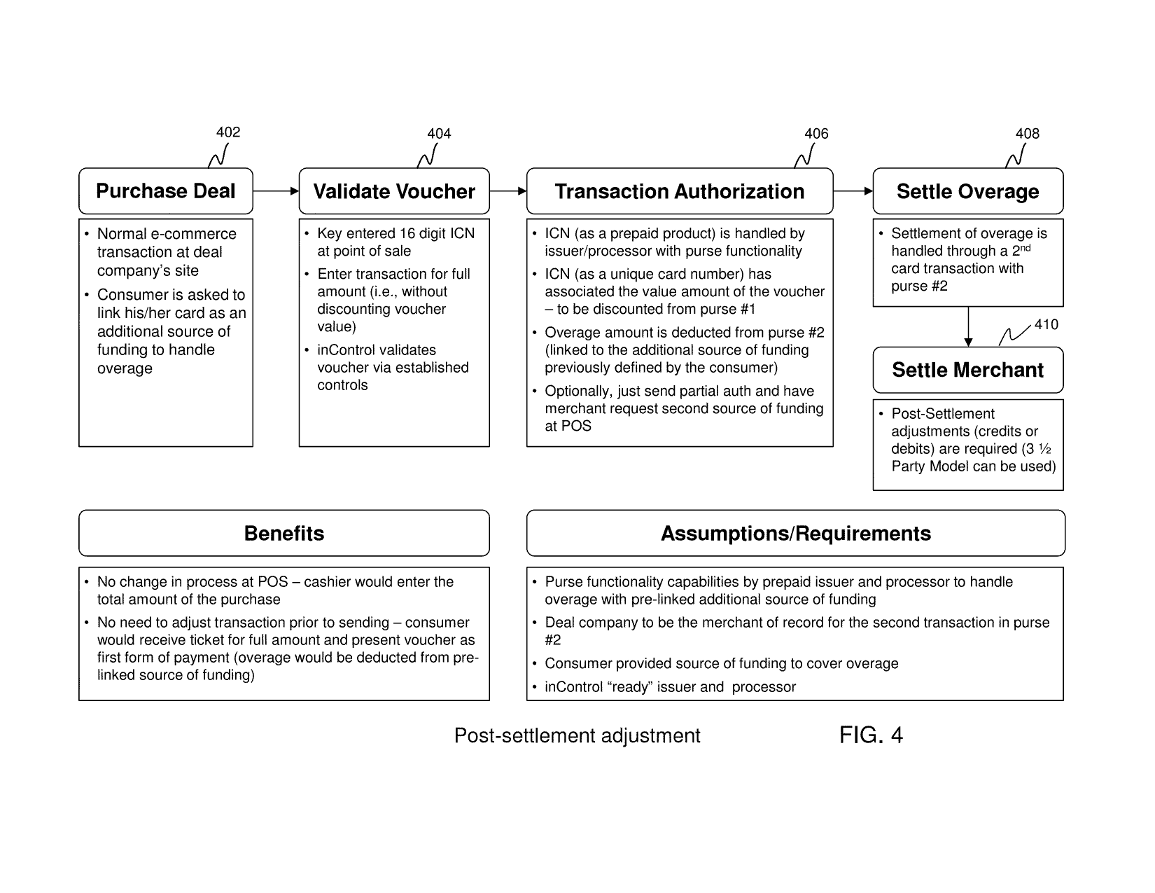

Assuming the transaction is approved, the merchant 104 would complete that transaction and additionally complete whatever other transaction is required to finalize the customer purchase. This other transaction can include charges for taxes, gratuities/tips, and overages for goods and services purchased in addition to the value of the voucher. In one embodiment, the validation transaction would be cleared and settled by all parties as any other transaction the merchant 104 ran that day. For example, these monies would settle in the usual manner of financial card transactions via the four parties for the voucher amount, with the overage being handled according to the embodiments described below with reference to FIGS. 4-10.

It is envisioned that the customer/merchant POS interaction could use barcode scans and other communication technologies that could automate the above process. In addition, the voucher could be presented via a mobile app, rather than on a piece of paper. This is the basic ‘keyed’ interface, but not the only interface.

Generally, the deal distributor 102 does not participate in the validation process, except for customer service issues. The funding administrator 105 will still receive the authorization from the card payment processing network 103 and will need to make a decision in order for the card payment processing network 103 to forward the approval to the POS. The funding administrator 105 could decline the transaction as needed.

In one embodiment, the offer sponsor/merchant 104 reduces total purchase amount by the offer value.

With continued reference to FIG. 2, at step 208, the offer sponsor/merchant 104 submits offer redemption payment request using offer redemption code. The amount of this request will be $ORA. The redemption code/intelligent transaction card number may be used for partial payment of entire purchase amount. In this case, the offer sponsor/merchant 104 will request additional payment method for remaining balance of purchase amount.

In step 209, the VRS platform 103A verifies offer validity using offer redemption code submitted by the offer sponsor/merchant 104 along with offer details previously captured during the offer acceptance process. The VRS platform 103A will also ensure that offer redemption is consistent with offer terms specified by the offer distributor 102 (e.g., max number of uses). The VRS platform 103A will reject offer redemption payment requests for invalid offers or for purchases which do not meet offer terms as specified by the offer distributor 102. The VRS platform 103A identifies appropriate offer funding account at the offer funding administrator 105 based on the VCN/funding account link or card mapping established earlier in the offer acceptance process. See, e.g., the CPN Patents for further details of this process.

As shown in FIG. 2, in step 210, the payment processing network (e.g., MasterCard network) 103 forwards payment requests to the funding administrator 105. The funding administrator 105 processes request and reduces balance of offer funding account by $ORA. The funding administrator 105 responds to the payment processing network 103 with processing confirmation and approval. The payment processing network 103 responds to the offer sponsor/merchant 104 with approval of offer redemption payment request. $OV−$ORA=offer margin. This margin is shared by the organizations supporting the value chain as per agreed terms. Of course, this is only one way that each of the various entities can receive consideration. The service can be subscription rather than usage based, or combinations of various compensations mechanisms.

To summarize, the overage management environment includes the consumer 101 presenting the voucher to a merchant and the merchant enters the VCN into a card reader. This step can include the merchant submitting anywhere from zero to a dollar off of an authorization request, or the amount the merchant 104 is owed by the offer distributor 102 such as a daily deal provider. In this step, the offer verification and redemption system 103 (e.g., InControl™ by MasterCard) checks the validity of the offer and records the redemption which, as explained in greater detail with respect to FIG. 2 involves authorization 212 being sent from the offer funding administrator 105 to the merchant 104 (e.g., GroupOn's issue or provides final approval to the merchant). In this step, the merchant receives an approved/declined message as a result.

### Offer Settlement

Merchant systems will submit successful voucher validations to the payment network 103 for settlement. The transaction amount may be nominal (a penny or 10 cents) and may match the nominal amount that was configured for this offer. Because standard settlement processes will be followed, the nominal amount will be sent to the merchant. This amount is above and beyond what the customer paid for the voucher. The merchant was paid for the value of the deal directly by the deal distributor.

In accordance with an embodiment, the voucher can have a small nominal value; as such the funding administrator 105 will pay the merchant via normal payment processor settlement service as they do for all purchases on their issued cards. The deal distributor 102 would not normally receive nor pay funds as part of the voucher usage on the network in this example. Since the credit account at the funding administrator 105 is typically a customer or corporations liability, the funding administrator 105 has to consider if is going to statement and collect those funds.

Having described offer acceptance and offer verification and redemption, the offer settlement process will now be described with continued reference to FIG. 2.

In step 211, the offer funding administrator 105 settles with the payment processing network 103 for the amount $ORA, for example.

In step 212, the payment processing network 103 settles with the offer sponsor/merchant 104 for $ORA. The offer sponsor/merchant 104 receives settlement funds via existing payment processing network settlement process and, within existing payment processing network settlement timeframes, in this particular non-limiting embodiment.

In step 213, the offer funding administrator 105 shares offer margin amount with other parties 106 supporting the value chain in this embodiment, though other compensation mechanisms can be employed. Settlement of these funds may occur via nearly any mutually agreed process. Parties settled across include the offer distributor 102 (which can be multiple parties e.g., deal originators, deal aggregators, and deal publishers), offer sponsor/merchant 104, VRS platform 103A independently or as part of the payment processing network 103 and offer funding administrator 105.

In addition or alternatively, the intelligent transaction code (e.g., VCN) can be processed by the card processing system 103 as part of the authentication or redemption for a nominal amount to verify the intelligent transaction code is live and can be used. This nominal amount may be equal to the compensation to be paid to one or more entities (e.g., the payment processing network 103 for example).

### Offer Reporting

Having described the process through offer settlement, various reporting functions will now be described with continued reference to FIG. 2.

In step 214, offer acceptance and redemption data is collected in the VRS platform 103A database 103B. This data empowers value-added reporting by the offer verification service (OVA) 107 for the offer sponsor/merchant 104 and the offer distributor 102, and perhaps the data and associated analytics can be offered for lease, usage or sale to various third parties.

In step 215, value-added reports are distributed to the offer sponsor/merchant 104 and/or the offer distributor 102 in this exemplary embodiment. Reports may also employ transaction processing data for secondary payments, payment of additional fees not tied directly to the deal offer value, such as fees for collateral and convoyed sales whether at the same time or thereafter, rewards for attracting new repeat customers or customers for new co-branded cards, to name a few possibilities. These can be based on the transaction using the VCN supplied with or as the redemption code, through surveys or other forms of human reporting, or through use of co-branded or loyalty cards or promotion programs that tend to track sales that can be linked to acceptance of the initial offer in whatever manner. This will enable OVA to quantify sales “uplift” benefit to the offer sponsor/merchant 104.

The notification to the deal administrator of the usage could be an after-the-fact process, the funding administrator 105 could ‘tell/alert’ the deal distributor 102 when they approve the transaction via any one of several methods, including batch reports or single messages via a web interaction. Additionally both the funding administrator 105 and the deal distributor 102 can query the VRS data base 103c and receive usage information. However the notification process could also be real time using an SMS service to send and SMS message to a deal originator server. This has many positive customer service potentials.

Fraud or voucher audit controls are inherent in this solution as each VCN will have rules that would be designed to meet requirements of the deal distributor 102 and/or the fund administrator 105. Controls can lock the voucher down to a very singular usage footprint that it will severely hamper the customer or the merchant from abusing the system. VRS platform 103A will check that the voucher number has not been used previously, as well as validate the merchant's name, location and offer amount.

Trouble shooting and processing auditing can be done with the same underlining APIs to gain access to the data. Additionally, a web based servicing platform can be used in a call center to do transaction level research on an adhoc basis.

Transaction reports will be available via several methods. The funding administrator 105 will have a record of all the approved and declined voucher validation transactions along with overage information. Information in some forms, such as, but not limited to, overage amounts, might be shared with the deal distributor 102 for integration into their existing reporting systems. The VRS platform 103 can be used to report on the individual voucher on an adhoc basis as needed to support customer service functions. This service will allow for a full range of operational and MIS (Management Information System) reports. Initially these might be transactional in nature and would include information that would indicate counts, amounts and percent utilization etc. These will be offered as standard reporting with the service.

Additionally one might create analytical and market assessment type reports. These would leverage the mentioned data as well as data points that only our warehouse can uniquely derive and interpret.

### Consumer Interface and Database

In addition to the technology flow described above, there may be additional components provided as part of the solution. For example, a database, such as, but not limited to, a relational database, can be used to store all information generated by the VRS platform 103A at an individual consumer level. It can also store individual consumer information relating to merchant or category preferences, zip code, gender, propensity scores, transaction data, and program permissions. Database can also be matched with other data sources for purposes of refining targeting, reporting and analysis.

Targeting services provided could include targeting for program acquisition or ongoing marketing based on category preferences, zip code, gender, propensity scores, other data sources, and social media information (e.g., offers that friends liked). A consumer interface whereby consumers 101 can access offers as part of a website, mobile app, electronic wallet, or other means may also be included. Consumers 101 can also retrieve information on offers available, offers purchases, offers redeemed, total amount spent to date.

### Offer Marketing and Communications

The system can send a real time communication (text alert, email, app push or pull alert) to consumers from the offer distributor 102 or the offer sponsor/merchant 104 with messaging based on offer code or other analytics. Communication could service multiple purposes, including: offer use “confirmation” with a call to action to make an additional purchase with the offer sponsor/merchant 104 or the offer distributor 102, customer survey to solicit feedback, call to action to share information relating to the program, offer or other information with friends via social media means (e.g., Facebook) or email.

Leveraging OVS value-added reporting 107 and database information, system could also be leveraged to send offers or information to consumers at other times via multiple means including text, application notice or email. These messages could be targeted based on past transaction history, offers the consumers “friends” liked, etc. Sample message would be “Other users like you have really enjoyed this offer,” or “We miss you, and here is a special offer from the offer distributor 102 and/or offer sponsor/merchant.”

### Additional Design Elements/Considerations

The redemption solution leveraging intelligent transaction card numbers can be part of a larger, integrated solution, including but not limited to:

1) Offer targeting provided for both customer activation and new customer acquisition, as well as refining the types of offers shown or pushed to a given customer;

2) Comprehensive return-on-investment (ROI) reporting for campaigns (e.g., overage purchases above offer amount, offers bought/redeemed, average ticket, percentage of new customers, etc.);

3) “Consumer Central” (consumer front end) where the payment processor network 103 stores personally identifiable information (PII) and permissions from consumers, giving the payment processing network 103 rights to re-market to consumers; and

4) Pricing which provides additional motivation for consumers and merchants and deal aggregators for transacting with the payment processing network.

The redemption solution being deployed in various forms such as: 1) intelligent transaction card numbers on paper coupon and card payment; 2) intelligent transaction card numbers on mobile phone and card payment; and 3) intelligent transaction card numbers in mobile wallet, mobile payment.

The business model can be fee or profit-sharing: when settlement occurs, the split can occur between the merchant and aggregator, with the payment processing network also receiving some consideration.

Fully leveraging the offer data can be done in phases, depending on how seamlessly the redemption process is integrated with consumer enrollment. For example, at first the payment processing network would have no ability to tie the redemption of the offer to a specific enrollee and their redemption code number; a deal aggregator would get immediate benefits with less reliance on paper to effect redemption and track results, less fraudulent mis-use/re-use of offers, and quicker access to their share of the settlement split; and a merchant gets immediate benefits of easier redemption process by using conventional card network, quicker receipt of funds from settlement.

An alternative of this would be for the payment processing network to own consumer front-end and resulting database. This approach provides the ability to tie offers to specific consumers (tying intelligent transaction card numbers to the redemption code numbers of the consumer), provide the potential for capturing incremental spending (i.e., overages above offer value), improving targeting models, especially for customer activation, and providing a merchant portal allowing merchants to access select data, to name a few benefits.

### Method for Post-Settlement Adjustment

FIG. 4 depicts a method for overage management using post-settlement adjustment. FIG. 4 is described with continued reference to the embodiments illustrated in FIGS. 1-3. However, FIG. 4 is not limited to those embodiments.

As shown in FIG. 4, the post-settlement adjustment begins in step 402 where a normal e-commerce transaction at a deal company's site commences. In an optional embodiment, step 402 includes prompting or asking consumer 101 to link a card or account as an additional source of funding to handle any overage. In this optional embodiment, the linked card or account can be designate by consumer 101 to be used for a pre-determined overage amount (e.g., $20) or for a percentage of the voucher value (e.g., overages up to 50% of the voucher value can be charged to the linked card).

In step 404, a voucher associated with the deal is validated. This step comprises key or other form of entry of an intelligent transaction card number indicating a total amount of a transaction at a merchant 104, wherein the total amount includes a value of the redeemed offer for the deal purchased in step 402 and an overage spent by the consumer 101 at the merchant 104 in addition to the value of the redeemed offer. In one embodiment, the intelligent transaction card (ITC) number is a 16-digit Intelligent Coupon Number (ICN) keyed in a point-of-sale (POS) of merchant 104. That is, the ITC also serves as an ICN. Step 404 can include entry of a transaction for full amount of a voucher for the deal purchased in step 402 (i.e., without discounting voucher value). In an embodiment, step 404 uses InControl™ to validate the voucher via established controls. According to another embodiment, a message, such as an e-mail or SMS text message, can be sent to a mobile computing device associated with consumer 101 confirming that a discount has been applied after the voucher has been validated in step 404. In an alternative embodiment, a message can be sent in an optional data field to the POS at merchant 104 indicating on the payment receipt that a discount has been applied after voucher validation in step 404 has been completed.

In step 406, the transaction is authorized. This step can be accomplished with ICN being handled by issuer/processor with a purse functionality wherein the ICN is a unique card number and has associated the value amount of the voucher—to be discounted from a first purse (purse #1 as shown in FIG. 4). The overage amount is deducted from a second purse (purse #2 as shown in FIG. 4). The second purse can be linked to the additional source of funding previously defined by the consumer in step 402. Step 406 can optionally be performed by sending just a partial authorization and having merchant 104 requests a second source of funding at the POS.

In step 408, the overage is settled. As shown in FIG. 4, this step can comprise handling settlement of overage through a second card transaction with purse #2. Alternatively, a second transaction can be originated at the merchant's POS can be used if a secondary source of funding has been designated.

In step 410, merchant 104 is settled. Settlement of merchant funds in this step is facilitated via post-settlement adjustments (as credits or debits). In an embodiment, a financial adjustment platform, such as disclosed in U.S. Published Patent Application No. 2008/0005018 naming Jonathan Powell as the inventor (incorporated herein by reference), may be used for merchant settlement. As described in U.S. Published Patent Application No. 2008/0005018, such post-settlement adjustments occur later.

As shown in FIG. 4, advantages of using post-settlement adjustment include not requiring changes in the process at a POS of merchant 104, i.e., a cashier would enter the total amount of the purchase. Another advantage to this approach is that there is no need to adjust the transaction prior to sending—consumer 101 would receive a ticket for the full amount and present the voucher as first form of payment, with the overage being deducted from pre-linked source of funding, with payment processing network 103, such as MasterCard, being the merchant of record for that transaction. In an alternative embodiment, the adjustment can occur post-transaction and pre-settlement.

### Method Using Non-Settlement Product

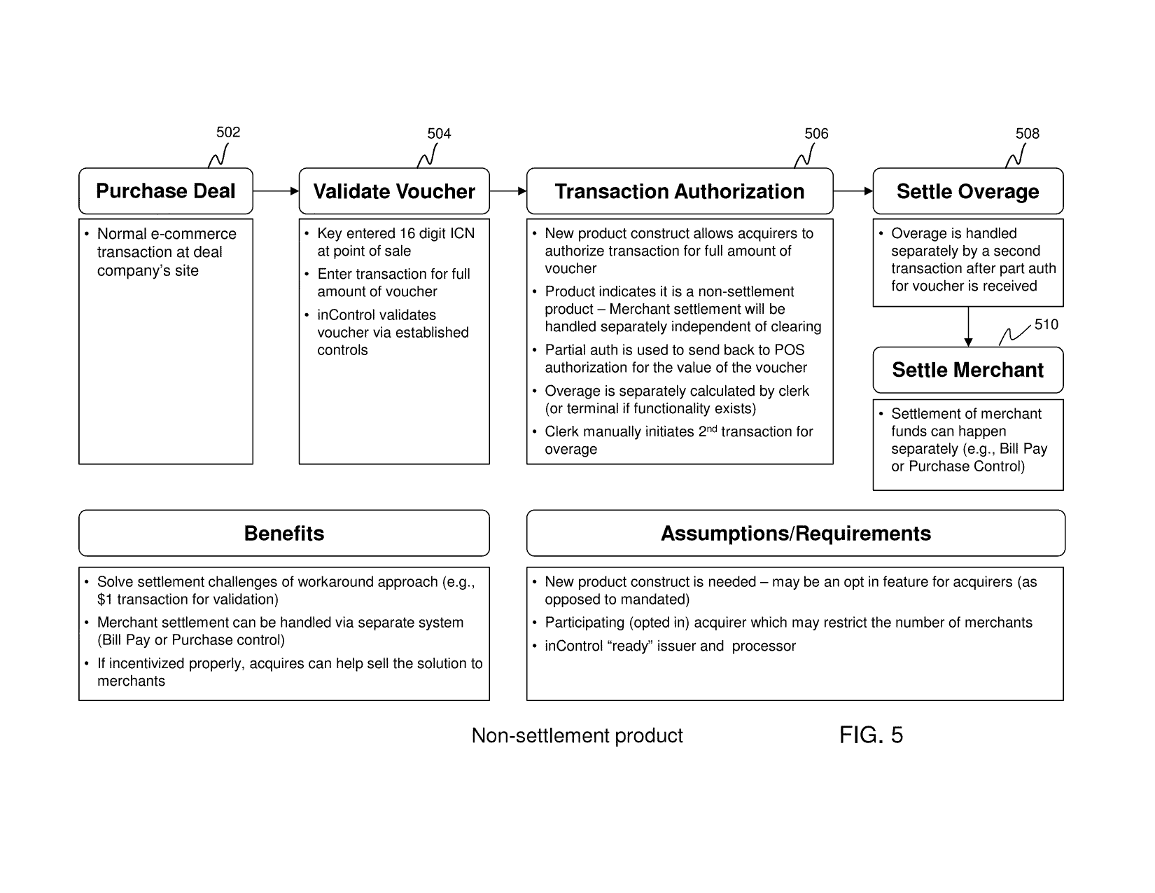

FIG. 5 depicts a method for overage management using a non-settlement product, according to an exemplary embodiment of the present disclosure. FIG. 5 is described with continued reference to the embodiments illustrated in FIGS. 1-3. However, FIG. 5 is not limited to those embodiments. With the non-settlement product, an acquirer knows about the overage, but does not settle payment. That is, settlement of the overage is separate from authorizing and clearing the voucher.

As shown in FIG. 5, the post-settlement adjustment begins in step 502 where a normal e-commerce transaction at a deal company's site commences and then control is passed to step 504.

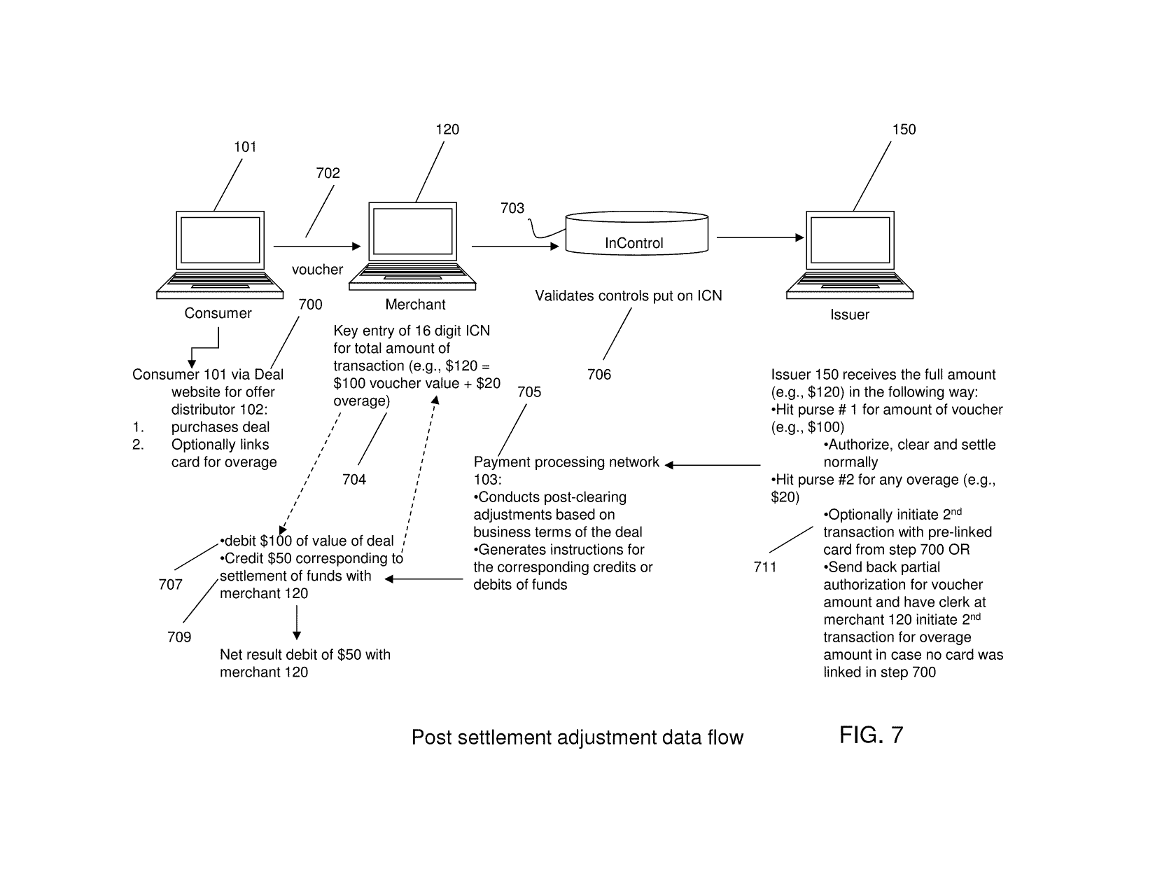

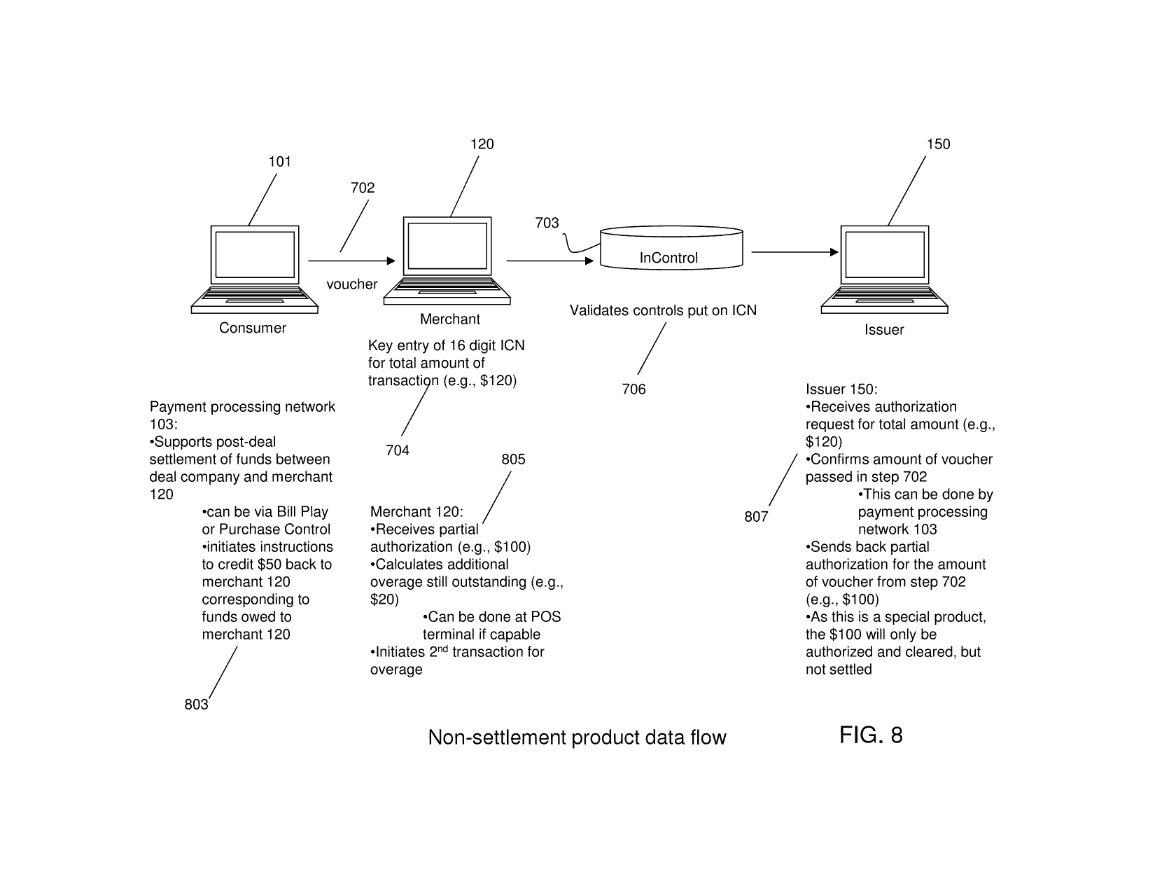

In step 504, a voucher associated with the deal is validated. This step comprises key entry of an intelligent transaction card number indicating a total amount of a transaction at a merchant 104, wherein the total amount includes a value of the redeemed offer for the deal purchased in step 502 and an overage spent by the consumer 101 at the merchant 104 in addition to the value of the redeemed offer. In one embodiment, the intelligent transaction card number is a 16-digit Intelligent Coupon Number (ICN) keyed in a point-of-sale (POS) of merchant 104. Step 504 can include entry of a transaction for full amount of a voucher for the deal purchased in step 502. In an embodiment, step 504 uses InControl™ to validate the voucher via established controls. In another embodiment, step 504 comprises a merchant 104 sending a request for approval of the full amount of the voucher and the overage (e.g., $120 in the example embodiment describe with reference to FIG. 8 below), but only the voucher amount (e.g., $100 as shown in FIG. 7) is initially approved, with the overage (e.g., $20 as shown in FIG. 7) is processed as a separate transaction. In step 506, the transaction is authorized. This step can be accomplished with a new product construct, which allows acquirers to authorize a transaction for the full amount of the voucher. In this step, this new product can indicate that it is a non-settlement product and merchant 104 settlements will be handled separately and independent of clearing. Alternatively settlement could be handled in this step with interchange at 100% (net $0.00). In step 506, partial authorization can be used to send back to the POS of merchant 104 authorizations for the value of the voucher. Overage can then be separately calculated by a clerk (or a POS terminal if functionality exists at the POS). In this step, a clerk at merchant 104 can manually initiate a second transaction for overage. In an alternative embodiment of step 506, a payment processing network 103, such as MasterCard, acting as a merchant of record.

In step 508, the overage is settled. As shown in FIG. 5, this step can comprise handling the overage separately by a second transaction after partial authorization for the voucher is received. In an embodiment, this step can be performed by an overage payment module configured to make use of a card previously linked by a consumer 101.

In step 510, merchant 104 is settled. Settlement of merchant funds in this step happens separately (e.g., via Purchase Control™ or Bill Pay™) wherein the merchant 104 is paid for an amount less than the full, ‘face value’ of the voucher (i.e., a merchant may only receive 50% of the face value of a voucher).

As shown in FIG. 5, advantages of using the non-settlement product include avoiding settlement challenges of a workaround approach and handling merchant settlement via a separate system such as, but not limited to, Purchase Control™ or Bill Pay™.

### Method for Overage Tracking

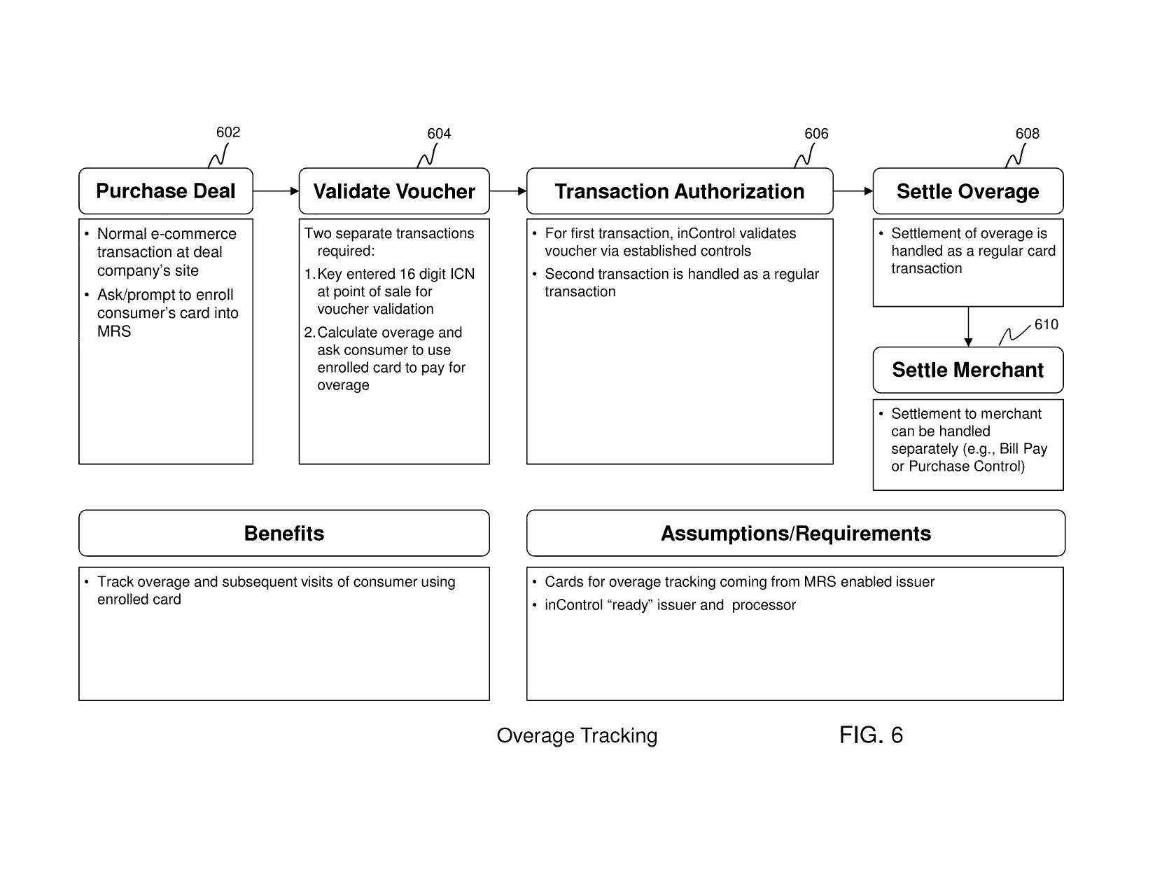

FIG. 6 depicts a method for overage management using overage tracking. FIG. 6 is described with continued reference to the embodiments illustrated in FIGS. 1-3. However, FIG. 6 is not limited to those embodiments.

Overage tracking begins in step 602 where a normal e-commerce transaction at a deal company's site commences. In one embodiment, this step can include prompting or asking a consumer 101 to enroll their card into a loyalty program such as, but not limited to the MasterCard Rewards Services (MRS). This example embodiment can induce such enrollment by offering incentive to do so. In an embodiment of step 602, when a consumer 101 visits merchant 104 (either on-line or at a ‘brick and mortar’ location), the consumer 101 presents a voucher to merchant 104 and merchant 104 subsequently validates the voucher amount, i.e., in step 604 described below. According to this embodiment, a clerk at merchant 104 can separate the overage from the voucher amount and the consumer 101 approves use of his/her loyalty card for the overage amount. The coupon/meta data returned to the merchant returned as part of the transaction, or another communication path (i.e., an SMS message) can be used to prompt the consumer 101 or a clerk at the merchant to use the enrolled loyalty card.

In step 604, a voucher associated with the deal is validated. This step comprises key entry of an intelligent transaction card number indicating a total amount of a transaction at a merchant 104, wherein the total amount includes a value of the redeemed offer for the deal purchased in step 602 and an overage spent by the consumer 101 at the merchant 104 in addition to the value of the redeemed offer. In one embodiment, the intelligent transaction card number is a 16-digit Intelligent Coupon Number (ICN) keyed in the point-of-sale (POS) of merchant 104. Step 604 can include calculating the overage and asking consumer 101 to use the enrolled card from step 602 to pay for the overage.

In step 606, the transaction is authorized. This step can be accomplished with two transactions. In the first transaction, InControl™ can validate the voucher via established controls. Then, a second transaction is handled as a regular transaction.

In step 608, the overage is settled. As shown in FIG. 6, this step can comprise handling the overage as a regular card transaction.

In step 610, merchant 104 is settled. Settlement of merchant funds in this step happens separately (e.g., via Purchase Control™ or Bill Pay™)

As shown in FIG. 6, advantages of using overage tracking include being able to track overage and subsequent visits of a consumer 101 using the enrolled card from step 602.

### Data Flow for Post-Settlement Adjustment

FIG. 7 is a data flow diagram depicting an example transaction for the post-settlement adjustment method depicted in FIG. 4. The example transaction in each of FIGS. 7-9 is redemption of a $100 voucher occurring in conjunction with a $20 overage spent by a consumer 101 at a merchant 104. FIG. 7 is described with continued reference to the embodiment illustrated in FIG. 4. However, FIG. 7 is not limited to that embodiment. The steps of the post-settlement adjustment method shown in FIGS. 4 through 7 do not necessarily have to occur in the order described. As noted above with reference to FIG. 4 and below with reference to FIG. 7, some of the steps are optional. FIG. 7 depicts how three key functionalities are tied together for post-settlement adjustment. These three functionalities are: multiple purse functionality; post-settlement adjustment using direct issuer-merchant relationships; and use of InControl™ ICN generated vouchers.

In step 700, a consumer 101 purchases a deal via deal website from offer distributor 102. As described above with reference to FIG. 4, consumer 101 can optionally link a card for overage in this step.

In step 702, a voucher corresponding to the deal purchased in step 700 is sent to merchant 104.

In step 704, key entry of a 16-digit ICN is done for the total amount of a transaction. In the example shown in FIG. 7, this total is $120, with a $100 voucher value and a $20 overage.

In step 705, payment processing network 103 conducts post-clearing adjustments based on business terms of the deal and generates instructions for the corresponding credits or debits of funds.

In step 706 controls put on the ICN are validated. This step may be accomplished through use of an InControl™ database 703.

In step 707, a debit $100 of value of deal is processed and in step 709, a credit $50 corresponding to settlement of funds with merchant 104 occurs, resulting in a net result debit of $50 with merchant 104.

In step 711, issuer 150 receives the full amount for the voucher plus the overage (e.g., $120) as follows. Issuer 150 first hits purse # 1 for the amount of voucher (e.g., $100), authorizes, clears and settles normally, and then hits purse #2 for any overage (e.g., $20). In step 711, a 2nd transaction is optionally initiated with pre-linked card from step 700. In an alternative embodiment, this step comprises sending back a partial authorization for the voucher amount and having a clerk at merchant 104 initiate a second transaction for the overage amount in case no card was linked in step 700.

### Data Flow for Non-Settlement Product

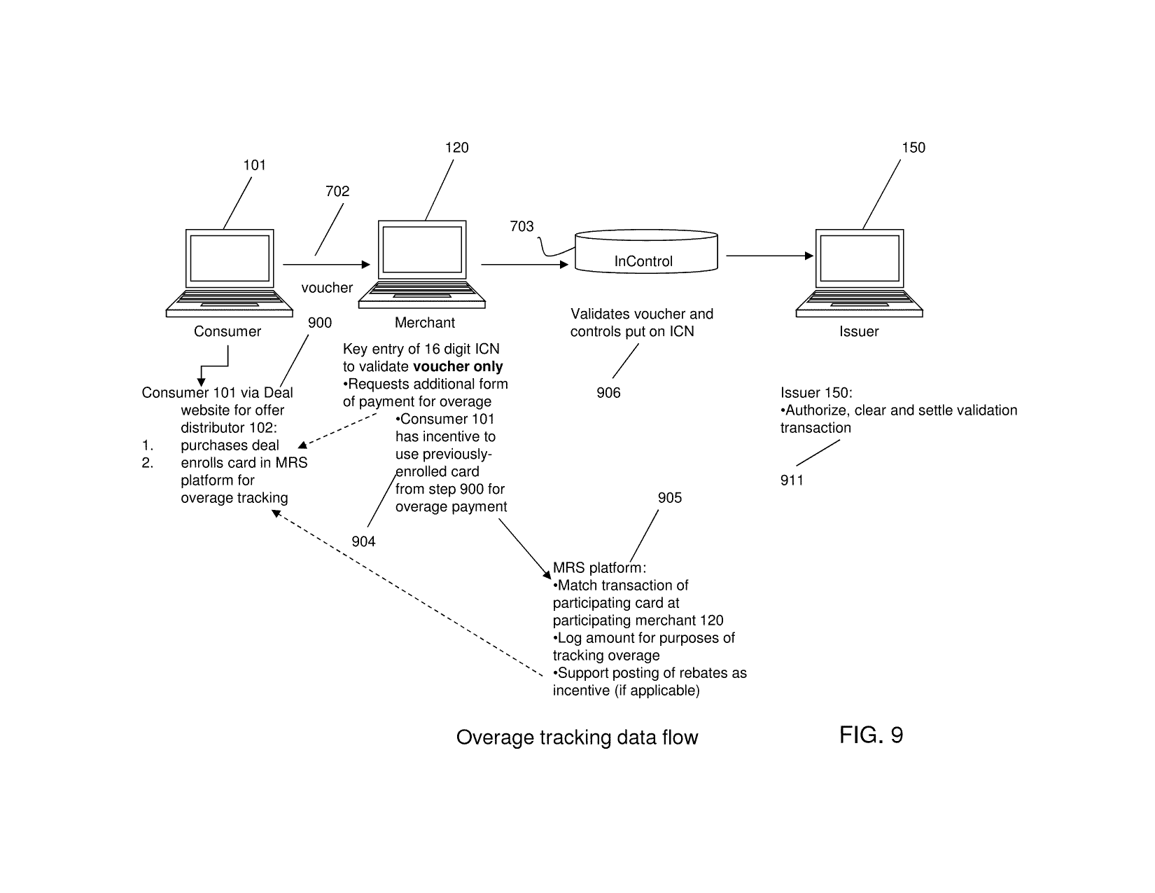

FIG. 8 is a data flow diagram for the non-settlement product depicted in FIG. 5. FIG. 8 is described with continued reference to the embodiment illustrated in FIG. 5. However, FIG. 8 is not limited to that embodiment. For brevity, only the differences occurring within FIGS. 8 and 9, as compared to previous or subsequent ones of the FIGS. 7-9, are described below.

In step 803, payment processing network 103 supports post-deal settlement of funds between deal company and merchant 104. As noted above with reference to FIG. 5, this can be handled be via Purchase Control™ or Bill Pay™. In this step, instructions are initiated to credit $50 back to merchant 104 corresponding to funds owed to merchant 104.

In step 805, merchant 104 receives partial authorization (e.g., $100) and then calculates additional overage still outstanding (e.g., $20). This step can be done at a POS terminal at merchant 104 if the terminal is capable of performing such calculations. Step 805 further comprises initiating a second transaction for the overage.

In step 807, issuer 150 receives authorization request for total amount (e.g., $120) and confirms amount of voucher passed to merchant 104 in step 702. Step 807 can be done by payment processing network 103. This step includes sending back partial authorization for the amount of the voucher (e.g., $100). As noted in FIG. 8, as this is a special product, the $100 will only be authorized and cleared, but not settled. Alternatively settlement could be handled in this step with interchange at 100% (net $0.00).

### Data Flow for Overage Tracking

FIG. 9 is a data flow diagram for the overage tracking depicted in FIG. 6. FIG. 9 is described with continued reference to the embodiment illustrated in FIG. 6. However, FIG. 9 is not limited to that embodiment. FIG. 9 depicts the combination of two platforms: InControl™ (to generate ICNs) and MRS (to track spending).

In step 900, consumer 101 purchases a deal via Deal website from offer distributor 102 and optionally enrolls his/her card in MRS platform for overage tracking.

In step 904, key entry of a 16 digit ICN is done to validate the voucher only and a request is generated for an additional form of payment for the overage. As shown in FIG. 9, the consumer 101 can be incentivized to use a previously-enrolled card from step 900 for the overage payment.

In step 905, the MRS platform can be used to match transaction of participating card at participating merchant 104 and log amounts for purposes of tracking overage. This step supports posting of rebates as incentives (if applicable).

In step 906, the voucher and controls put on ICN are validated. This step can be accomplished through use of the InControl™ database 703.

In step 911, issuer 150 authorizes, clears and settles the validation transaction.

### Deal Processing Platform

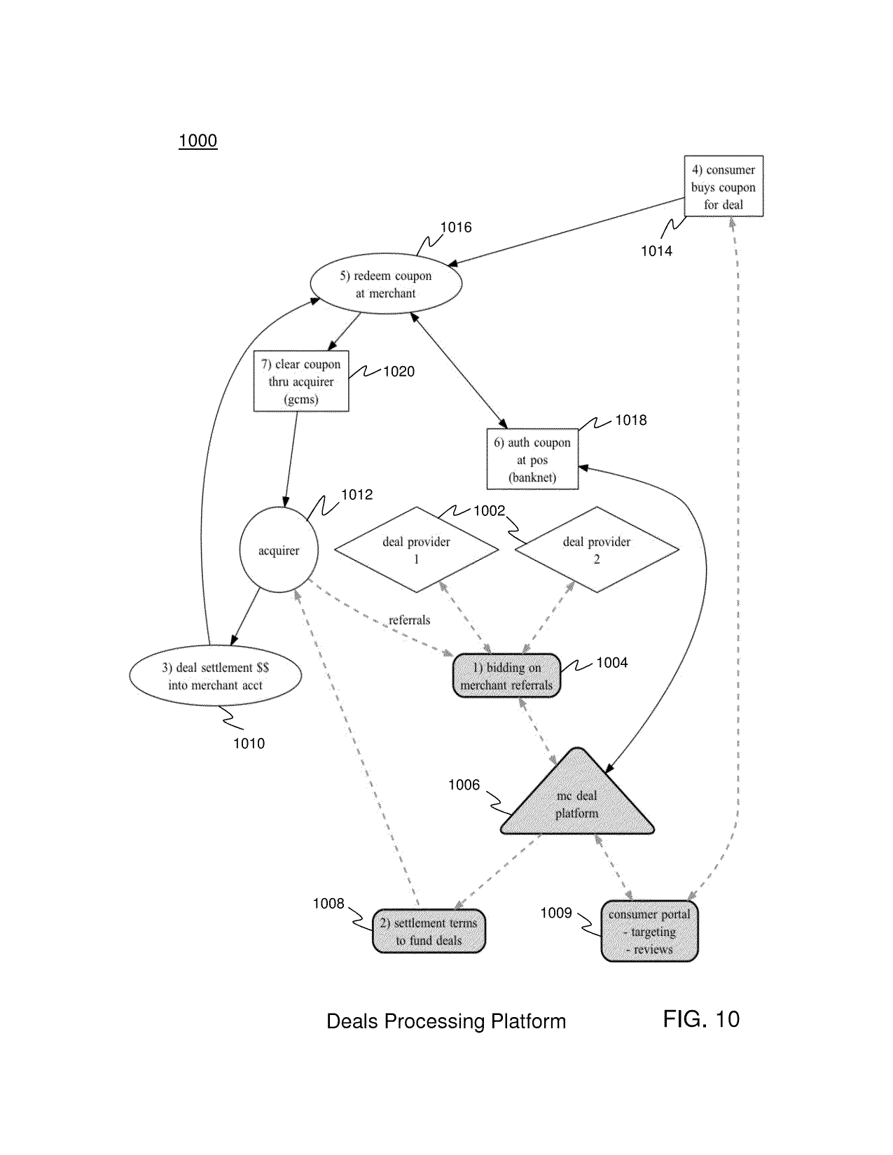

FIG. 10 is a data flow diagram for deals processing platform 1000 that can be used to implement the non-settlement product described above with reference to FIGS. 5 and 8. FIG. 10 is described with continued reference to the embodiments illustrated in FIGS. 1-3, 5 and 8. However, FIG. 10 is not limited to those embodiments.

Deals processing platform 1000 is a four party model—linking consumers 101, deal providers 1002 (such as offer distributors 102), acquirers 1012, and merchants 104 in order to enable implementation of the non-settlement product depicted in FIGS. 5 and 8. Deals processing platform 1000 allows acquirers 1012 to provide referrals of merchants 104 interested in participating in unique deals (time based, limited quantity, etc.) for deal providers 1002 to bid on. Consumers 101 can purchase the deals through a consumer website, allowing them to rate the deals and merchants (i.e., after deal providers bid on merchant referrals using referral module 1004) and make recommendations to others via social media (i.e., at consumer portal 1009).

In one embodiment, relevant deals are presented to consumers 101 based on preferences, deal/merchant rating thresholds, and transaction history (including registered cards). Deal platform 1006 shown in FIG. 10 can support a deal validation service to ensure only qualified consumers receive the deals, and a clearinghouse 1020 for the funding of the deals between the deal providers and merchants 104 through existing acquirer processing and relationships.

The deals processing platform 1000 supports the following functions: a database of merchant referrals (i.e., as part of referral module 1004), bid management, a database of merchant deals, settlement processing (i.e., by settlement module 1008), consumer portal 1009, and report generation.

Additional functionality used as part of the deals processing platform 1000 includes creation of a new Product Code for an acquirer opt-in of program, with special processing—either authorize and clear only (no settlement), or settle with interchange at 100% (net $0.00) and Intelligent Coupon Number (ICN) functionality through InControl™.

Unique aspects of the deals processing platform 1000 include a bid management process (which can utilize referral module 1004) that allows merchants to get the best possible terms by having deal providers compete, while effort to recruit merchants is greatly reduced, product code processing which allows acquirers 1012 to separate settlement from the clearing function of approved/redeemed ICNs.

In deals processing platform 1000, settlement is “pushed” to merchants 104 from Deal Providers, thus providing flexibility in the following funding scenarios:

1) Single or periodic payments (credits or debits), independent ICN redemption activity;

2) Payments (credits or debits) based on ICN redemption activity;

3) Offset credits & debits against a pre-funded balance or credit account for later settlement; and

4) A combination of 1, 2 and/or 3 above.

Authorization submission can support the full value of the consumer transaction to be submitted into the platform, with approval of the ICN value to be returned as a “partial authorization”. This allows the “up-sell” component of a deal to be tracked by the VRS 103A.

With continued reference to FIG. 10, the following steps explain data flow between components of deals processing platform 1000:

1) Deal providers 1002 bid on merchant referrals submitted by acquirer 1012.

2) Settlement of deal terms is managed between deal providers 1002 and merchants 104 through acquirer 1012.

3) Acquirer 1012 submits funds to merchant in existing card processing settlement account (see step 1010).

4) Consumer 101 purchases deal and receives deal coupon with an ICN (see step 1014).

5) Consumer 101 redeems deal coupon at merchant 104 in step 1016.

6) Merchant uses the ICN to authorize transaction thru a POS device, obtaining approval for the value of the deal coupon in step 1018.

7) Then, the ICN is used to clear deal coupon value through the standard credit card clearing process in step 1020.

### Reverse Settlement and Additional Funding Mechanism

In accordance with an embodiment, reverse settlement with an additional funding mechanism is used to manage overages. In this embodiment, an ICN can be used for the full amount a voucher and the overage (e.g., $120 in the examples provided in FIGS. 7-9) and off-network reconciliation is conducted post-transaction. In this embodiment an initial charge to the consumer 101 for the voucher amount and overage occurs, with a subsequent discount being applied later. According to this embodiment, reverse settlement handles the extra funds paid to a merchant 104 as a result of entering the full amount initially and overage is charged to a consumer's 101 funding mechanism (e.g., a pre-paid card, credit card, or debit card). Unlike a spending purse which can trigger authorizations at the same time, in this embodiment, all the reconciliation happens ‘off the network.’

III. Example Computer System Implementation

It will be appreciated that one or more exemplary embodiments of the present invention can provide one or more advantages or none at all. For example, improved merchant and acquirer control over offer verification, redemption and authorization of the underlying financial transaction can be provided by leveraging conventional authorization processes. Techniques of one or more embodiments of the present system can allow verifying that the offer is able to be used for a given purchase at a given time, including steps such as determining if the offer is valid. The system can employ hardware and/or software aspects. Software includes but is not limited to firmware, resident software, microcode, etc., that has been compiled to program a general purpose computer to be a specific purpose computer, or run a specific purpose computer.

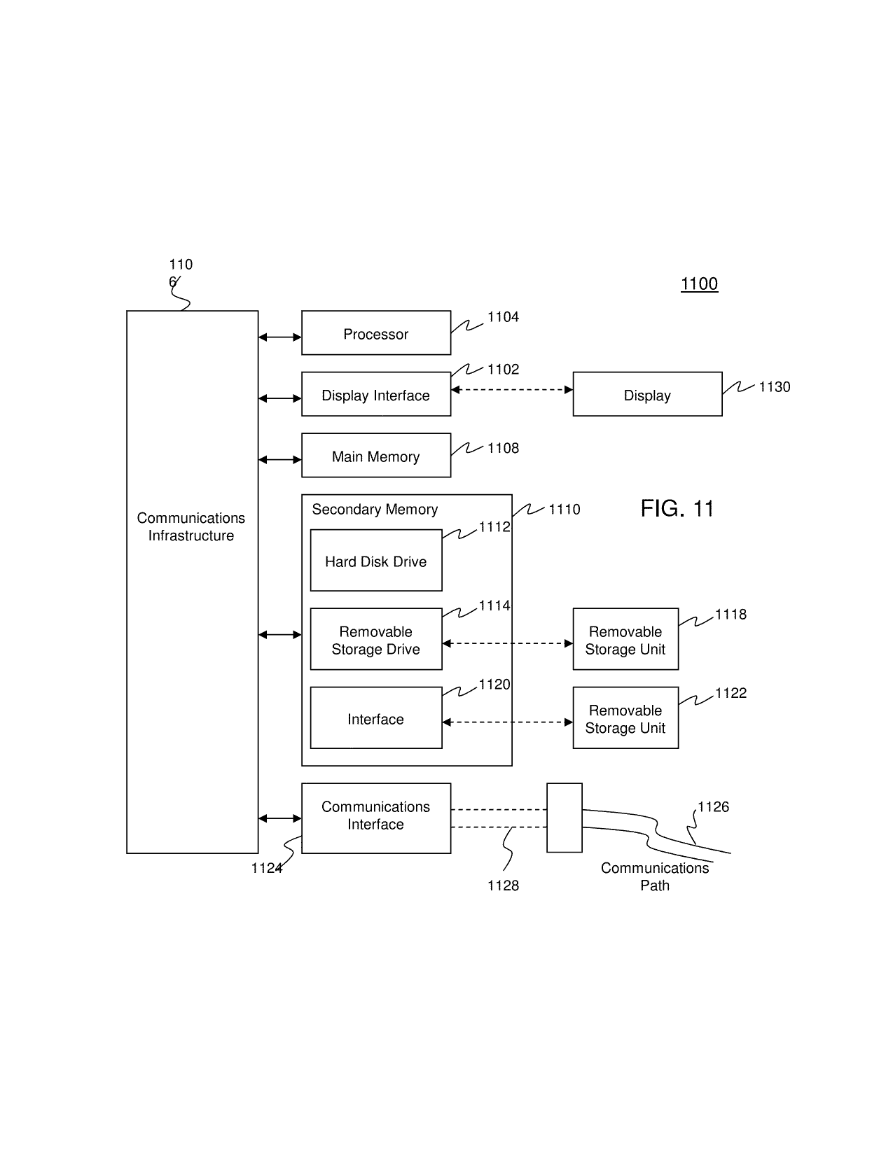

As described below with reference to FIG. 11, software might be employed, for example, in connection with one or more of terminals of the consumer 101, the offer distributor 102, and the payment processing network 103, the offer sponsor/merchant 104 or the financial administrator 105. Firmware might be employed, for example, in connection with payment devices such as cards 102, 112 or POS terminals. Different method steps can be performed by different processors. The database 103B memory could be distributed or local and the processors could be distributed or singular. The memory devices could be implemented as an electrical, magnetic or optical memory, or any combination of these or other types of storage devices (including memory portions as described above with respect to cards. It should be noted that if distributed processors are employed, each distributed processor that makes up a processor carrying out a function or step generally contains its own addressable memory space. It should also be noted that some or all of computer systems can be incorporated into an application-specific or general-use integrated circuit. For example, one or more method steps could be implemented in hardware in an ASIC rather than using firmware. Displays used in conjunction with each of the entities and processors are representative of a variety of possible input/output devices.

As would be appreciated by someone skilled in the relevant art(s) and described below with reference to FIG. 11, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards). Any tangible medium known or developed that can store information suitable for use with a computer system may be used. The computer-readable code means is any mechanism for allowing a computer to read instructions and data, such as magnetic variations on a magnetic media or optical characteristic variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, e.g., by processing capability on elements 101 (i.e., a computing device associated with consumer 101), 102, 103, 104, 105 or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor.

By way of example, a terminal apparatus associated with each of 101 through 105 could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe). By way of yet a further example, an active file manager apparatus for processing an active file in a payment system, could include a memory, and at least one processor coupled to the memory. The processor can be operative to perform one or more method steps described herein, or otherwise facilitate their performance.

Aspects of the present disclosure shown in FIGS. 1-10, or any part(s) or function(s) thereof, may be implemented using hardware, software modules, firmware, tangible computer readable media having instructions stored thereon, or a combination thereof and may be implemented in one or more computer systems or other processing systems.

FIG. 11 illustrates an example computer system 1100 in which embodiments of the present disclosure, or portions thereof, may be implemented as computer-readable code. For example, architecture 100 and system 300 of FIGS. 1-3, can be implemented in computer system 1100 using hardware, software, firmware, non-transitory computer readable media having instructions stored thereon, or a combination thereof and may be implemented in one or more computer systems or other processing systems. Hardware, software, or any combination of such may embody any of the modules and components used to implement the architectures and systems of FIGS. 1 and 3. Similarly, hardware, software, or any combination of such may embody modules and components used to implement the methods of FIGS. 4-10.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the present disclosure are described in terms of this example computer system 1100. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1104 may be a special purpose or a general purpose processor device. As will be appreciated by persons skilled in the relevant art, processor device 1104 may also be a single processor in a multi-core/multiprocessor system, such system operating alone, or in a cluster of computing devices operating in a cluster or server farm. Processor device 1104 is connected to a communication infrastructure 1106, for example, a bus, message queue, network, or multi-core message-passing scheme.

Computer system 1100 also includes a main memory 1108, for example, random access memory (RAM), and may also include a secondary memory 1110. Secondary memory 1110 may include, for example, a hard disk drive 1112, removable storage drive 1114. Removable storage drive 1114 may comprise a floppy disk drive, a magnetic tape drive, an optical disk drive, a flash memory, or the like.

The removable storage drive 1114 reads from and/or writes to a removable storage unit 1118 in a well-known manner. Removable storage unit 1118 may comprise a floppy disk, magnetic tape, optical disk, etc. which is read by and written to by removable storage drive 1114. As will be appreciated by persons skilled in the relevant art, removable storage unit 1118 includes a non-transitory computer usable storage medium having stored therein computer software and/or data.

In alternative implementations, secondary memory 1110 may include other similar means for allowing computer programs or other instructions to be loaded into computer system 1100. Such means may include, for example, a removable storage unit 1122 and an interface 1120. Examples of such means may include a program cartridge and cartridge interface (such as that found in video game devices), a removable memory chip (such as an EPROM, or PROM) and associated socket, and other removable storage units 1122 and interfaces 1120 which allow software and data to be transferred from the removable storage unit 1122 to computer system 1100.

Computer system 1100 may also include a communications interface 1124. Communications interface 1124 allows software and data to be transferred between computer system 1100 and external devices. Communications interface 1124 may include a modem, a network interface (such as an Ethernet card), a communications port, a PCMCIA slot and card, or the like. Software and data transferred via communications interface 1124 may be in the form of signals, which may be electronic, electromagnetic, optical, or other signals capable of being received by communications interface 1124. These signals may be provided to communications interface 1124 via a communications path 1126. Communications path 1126 carries signals and may be implemented using wire or cable, fiber optics, a phone line, a cellular phone link, an RF link or other communications channels.

In this document, the terms “computer program medium,” “non-transitory computer readable medium,” and “computer usable medium” are used to generally refer to tangible media such as removable storage unit 1118, removable storage unit 1122, and a hard disk installed in hard disk drive 1112. Signals carried over communications path 1126 can also embody the logic described herein. Computer program medium and computer usable medium can also refer to memories, such as main memory 1108 and secondary memory 1110, which can be memory semiconductors (e.g. DRAMs, etc.). These computer program products are means for providing software to computer system 1100.

Computer programs (also called computer control logic) are stored in main memory 1108 and/or secondary memory 1110. Computer programs may also be received via communications interface 1124. Such computer programs, when executed, enable computer system 1100 to implement the present disclosure as discussed herein. In particular, the computer programs, when executed, enable processor device 1104 to implement the processes of the present disclosure, such as the stages in the methods illustrated by FIGS. 4-6, discussed above. Accordingly, such computer programs represent controllers of the computer system 1100. Where the present disclosure is implemented using software, the software may be stored in a computer program product and loaded into computer system 1100 using removable storage drive 1114, interface 1120, and hard disk drive 1112, or communications interface 1124.

Embodiments of the present disclosure also may be directed to computer program products comprising software stored on any computer useable medium. Such software, when executed in one or more data processing device, causes a data processing device(s) to operate as described herein. Embodiments of the present disclosure employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the present invention that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the claimed invention should not be limited by any of the above-described exemplary embodiments, but should be defined only in accordance with the following claims and their equivalents.

Accordingly, it will be appreciated that one or more embodiments of the present invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

While the present invention has been particularly described with reference to exemplary embodiments thereof, it will be understood by those skilled in the art that various modifications and alterations may be made without departing from the spirit and scope of the invention. Accordingly, the disclosed embodiments of the invention are considered merely illustrative, and the invention is limited in scope only as specified in the appended claims.

What is claimed is:

1. A method of post-settlement adjustment for managing overages for offers redeemed by consumers, the method comprising:
receiving an indication of redemption of an offer by a consumer;
receiving an intelligent transaction card number used with a redemption code to purchase products or services contained in the redeemed offer, wherein the intelligent transaction card number indicates a total amount of a transaction at a merchant, wherein the total amount includes a value of the redeemed offer and an overage spent by the consumer at the merchant in addition to the value of the redeemed offer;
conducting, in a payment processing network, post-clearing adjustments based on terms of the redeemed offer;
generating, by the payment processing network, instructions for corresponding credits or debits of funds by:
debiting the value of the redeemed offer; and
crediting a value corresponding to settlement of funds with the merchant where the offer was redeemed;
receiving, from a card issuer, instructions to transfer funds from a first purse for the value of the redeemed offer;
authorizing, clearing and settling the transferred funds; and
receiving, from the card issuer, instructions to transfer funds from a second purse for the overage.

2. The method of claim 1, further comprising:
receiving, from the card issuer, authorization for the value of the redeemed offer; and
receiving, from the merchant, a separate transaction for the overage.

3. The method of claim 1, further comprising receiving an indication of a consumer account linked to the offer to cover the overage.

4. The method of claim 3, wherein the consumer account is a consumer card linked via a registration at an offer distributor website.

5. The method of claim 3, further comprising initiating a second transaction with the consumer account to cover the overage.

6. The method of claim 1, wherein the intelligent transaction card number is an Intelligent Coupon Number (ICN).

7. The method of claim 6, wherein the ICN is received from the merchant where the offer was redeemed.

8. The method of claim 7, wherein the ICN is a 16-digit value entered at a point-of-sale (POS) terminal at the merchant.

9. The method of claim 1, further comprising validating one or more controls put on the intelligent transaction card number;
wherein a voucher is associated with the redeemed offer, and
wherein the total amount includes a value of the voucher and an overage spent by the consumer at the merchant in addition to the value of the voucher.

10. The method of claim 9, wherein the value corresponding to settlement of funds is a pre-determined percentage of the value of the voucher.

11. The method of claim 9, wherein the one or more controls include at least one of:
time(s) of day the voucher can be used;
day(s) of week the voucher can be used;
date(s) the voucher can be used;
geographic location(s) where the voucher can be used;
one or more merchants where the voucher can be used;
type(s) of merchants where the voucher can be used;
an age range of the consumer; and
a maximum overage that may be spent together with the voucher.

12. The method of claim 1, further comprising, after the generating, sending a notification confirming that a discount corresponding to the value of the redeemed offer has been applied.

13. The method of claim 12, wherein the notification is an e-mail message or an SMS text message sent to a mobile computing device associated with the consumer.

14. The method of claim 12, wherein the notification is sent in an optional data field to a point-of-sale (POS) terminal at the merchant.

15. A method of managing overages for offers redeemed by consumers using a non-settlement product, the apparatus comprising:
receiving an indication of redemption of an offer by a consumer;
receiving an intelligent transaction card number used with a redemption code to purchase products or services contained in the redeemed offer, wherein the intelligent transaction card number indicates a total amount of a transaction at a merchant, wherein the total amount includes a value of the redeemed offer and an overage spent by the consumer at the merchant in addition to the value of the redeemed offer;
sending a partial approval to the merchant, wherein the partial approval includes authorization for the value of the redeemed offer;
settling the value of the redeemed offer as a first transaction; and
processing the overage as a second transaction.

16. The method of claim 15, further comprising means for receiving, from the merchant, the overage outstanding after the partial approval.

17. The method of claim 16, further comprising calculating the overage by a point-of-sale (POS) terminal at the merchant.

18. The method of claim 15, further comprising:
sending, to a card issuer, an authorization request for the total amount;
confirming, at a payment processing network, the value of the redeemed offer as compared to an associated voucher; and
wherein the partial approval is send by the payment processing network as a partial authorization for a value of the voucher, and wherein the value of the voucher is authorized and cleared, but not settled.

19. A method of tracking overages for vouchers redeemed by consumers within a payment processing network, the method comprising:
receiving an indication of redemption, by a consumer, of a purchased voucher, the voucher having been purchased with an account previously-enrolled in the system;
receiving an intelligent transaction card number used with a redemption code to purchase products or services contained in the voucher, wherein the intelligent transaction card number indicates a total amount of a transaction at a merchant, wherein the total amount includes an amount of the voucher and an overage spent by the consumer at the merchant in addition to the amount of the voucher;
using the received intelligent transaction card number to validate the voucher;
processing, in the payment processing network, a transaction for a nominal amount to enable subsequent processing of the overage without settlement challenges;
receiving an overage calculated at the merchant;
requesting an additional form of payment for the overage in response to determining that the previously-enrolled account is not authorized to be used to pay for the overage; and
processing the calculated overage within the payment processing network.

20. The method of claim 19, further comprising:
matching the transaction of the previously-enrolled account at the merchant;
logging the amount for purposes of tracking overage; and
posting rebates as an incentive to the consumer to enroll an account with the system, wherein the matching, logging and posting are done by a rewards services platform.

21. The method of claim 19, wherein the intelligent transaction card number is a 16-digit Intelligent Coupon Number (ICN) received via a point-of-sale (POS) terminal at the merchant where the voucher was redeemed.

22. A method post settlement adjustment for averages in offer redemption, comprising:
receiving referrals of merchants interested in participating in one or more deals for a plurality of deal providers to bid on;
presenting the one or more deals to consumers via a consumer website, wherein the website enables consumers to:
rate the deals;
rate the merchants; and
make recommendations to others regarding the deals and merchants via social media;
validating consumers to ensure that only qualified consumers receive the deals;
receiving indication of redemption, by a consumer, of a purchased deal, wherein the indication identifies a total amount of a transaction at a merchant, wherein the total amount includes a value of the redeemed deal and an overage spent by the consumer at the merchant in addition to the redeemed deal;
authorizing a coupon associated with the redeemed deal at a merchant; and
clearing funding of the redeemed deal between a provider of the purchased deal and the merchant via an acquirer.

23. The method of claim 22, wherein the deals are time-based or based on a limited quantity.

24. The computer readable storage medium of claim 22, wherein relevant deals are presented to consumers via the website based on previously-received consumer preferences, deal ratings, merchant rating thresholds, and transaction history for previously-registered consumer cards.
